(19) United States
(12) Patent Application Publication
(10) Pub. No.: US 2026/0095834 A1
(43) Pub. Date: Apr. 2, 2026

(54) RADIO LINK CONTROL SERVICE INTERRUPTION REDUCTION FOR WIRELESS COMMUNICATIONS

(71) Applicant: QUALCOMM Incorporated, San Diego, CA (US)

(72) Inventors: Vishal DALMIYA, San Diego, CA (US); Vaishakh RAO, San Diego, CA (US); Lulu WANG, San Diego, CA (US); Yiyi ZHANG, Poway, CA (US); Krishna Chaitanya BELLAM, Hyderabad (IN); Vanitha Aravamudhan KUMAR, San Diego, CA (US); Sherif ELAZZOUNI, San Diego, CA (US); Gavin Bernard HORN, La Jolla, CA (US); Sathish NALLAMANTI, Hyderabad (IN); Nileena P C, Hyderabad (IN); Abhijeet Khanna, San Diego, CA (US); Satyam NAMDEO, Hyderabad (IN); Sarat Bhargava Chinni, San Diego, CA (US)

(21) Appl. No.: 18/900,417

(22) Filed: Sep. 27, 2024

(51) Int. Cl. H04W 36/30; H04W 24/02; H04W 36/00

(52) U.S. Cl. CPC H04W 36/305; H04W 24/02; H04W 36/0085

(57) ABSTRACT

Methods, systems, and devices for wireless communications are described. In some cases, a user equipment may receive a control message including configuration information that enables the UE to autonomously select one or more characteristics of a radio link failure (RLF) procedure. Thus, the UE may select, autonomously, the one or more characteristics of the RLF procedure in accordance with the configuration information and may perform the RLF procedure in accordance with the one or more autonomously selected characteristics. In some example, the one or more characteristics may include one or more parameter values associated with prediction of an RLF. Additionally, or alternatively, the one or more characteristics may include one or more actions to be performed by the UE in response to the prediction of the RLF, a detection of the RLF, or both.

### FIELD OF TECHNOLOGY

The following relates to wireless communications, including radio link control (RLC) service interruption reduction for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A user equipment (UE) may select one or more characteristics of a radio link failure (RLF) procedure, which may provide one or more benefits, such as a reduced interruption time (e.g., between RLF occurrence and RLF detection, RLF resolution, or both). For example, the UE may select (e.g., using a machine learning (ML) model) one or more threshold quantities of retransmissions associated with prediction of RLF, detection of RLF, reporting of RLF, or any combination thereof. In some examples, the UE may receive, from a network entity, a control message indicating a first threshold quantity of retransmissions associated with declaration of RLF. The UE may select a second threshold quantity of retransmissions associated with prediction of RLF, where the second threshold quantity of retransmissions is less than the first threshold quantity of retransmissions. Thus, the UE may predict an RLF, based on a counted quantity of retransmissions exceeding the second threshold quantity of retransmissions, before the RLF occurs (e.g., before the counted quantity of retransmissions exceeds the first threshold quantity of retransmissions), such that the UE, the network entity, or both, may initiate one or more actions to resolve the RLF before the RLF occurs, reducing the interruption time.

Additionally, or alternatively, the UE may select (e.g., using the ML model or a different ML model) one or more actions to be performed (e.g., initiated) based on prediction of an RLF (e.g., reaching the second quantity of threshold retransmissions). For example, in some cases, the UE may transmit an indication of early RLF (e.g., declare RLF before the RLF occurs), may transmit an indication that RLF is predicted, may transmit a measurement report, or any combination thereof, based on the counted quantity of retransmissions exceeding the second threshold quantity of retransmissions (e.g., RLF being predicted). Additionally, or alternatively, in some examples, such as when the UE supports multiple communication links (e.g., dual connectivity), the UE may suspend a first communication link based on the counted quantity of retransmissions exceeding the second threshold quantity of retransmissions on the first communication link and may transmit, on a second communication link, an indication of the suspension of the first communication link.

A method for wireless communications by a UE is described. The method may include obtaining configuration information that enables the UE to select one or more characteristics of an RLF procedure, selecting, by the UE, the one or more characteristics of the RLF procedure in accordance with the configuration information, and performing the RLF procedure in accordance with the one or more selected characteristics.

A UE for wireless communications is described. The UE may include one or more memories storing processor executable code, and one or more processors coupled with the one or more memories. The one or more processors may individually or collectively be operable to execute the code to cause the UE to obtain configuration information that enables the UE to select one or more characteristics of a RLF procedure, select, by the UE, the one or more characteristics of the RLF procedure in accordance with the configuration information, and perform the RLF procedure in accordance with the one or more selected characteristics.

Another UE for wireless communications is described. The UE may include means for obtaining configuration information that enables the UE to select one or more characteristics of an RLF procedure, means for selecting, by the UE, the one or more characteristics of the RLF procedure in accordance with the configuration information, and means for performing the RLF procedure in accordance with the one or more selected characteristics.

A non-transitory computer-readable medium storing code for wireless communications is described. The code may include instructions executable by one or more processors to obtain configuration information that enables the UE to select one or more characteristics of a RLF procedure, select, by the UE, the one or more characteristics of the RLF procedure in accordance with the configuration information, and perform the RLF procedure in accordance with the one or more selected characteristics.

In some examples of the method, UEs, and non-transitory computer-readable medium described herein, operations, features, means, or instructions for selecting the one or more characteristics of the RLF procedure may include operations, features, means, or instructions for selecting one or more parameter values associated with prediction of an RLF, where the RLF procedure includes the prediction of the RLF.

Some examples of the method, UEs, and non-transitory computer-readable medium described herein may further include operations, features, means, or instructions for transmitting a control message indicative of the one or more selected parameter values.

In some examples of the method, UEs, and non-transitory computer-readable medium described herein, the configuration information may be indicative of one or more ranges of parameter values associated with the prediction of the RLF and each parameter value from the one or more selected parameter values may be selected from a respective range of parameter values included in the one or more ranges of parameter values.

In some examples of the method, UEs, and non-transitory computer-readable medium described herein, the one or more selected parameter values include a first threshold quantity of retransmissions that results in transmission of an RLF report, a second threshold quantity of retransmissions that results in the prediction of the RLF, or both.

In some examples of the method, UEs, and non-transitory computer-readable medium described herein, the one or more selected parameter values may be selected in accordance with one or more measurements performed by the UE, one or more operational parameters associated with the UE, one or more conditions associated with the UE, or any combination thereof.

In some examples of the method, UEs, and non-transitory computer-readable medium described herein, operations, features, means, or instructions for selecting the one or more parameter values may include operations, features, means, or instructions for inputting, into a machine learning (ML) model, the one or more measurements performed by the UE, the one or more operational parameters associated with the UE, the one or more conditions associated with the UE, or any combination thereof, where the one or more parameter values may be selected in accordance with an output of the ML model.

In some examples of the method, UEs, and non-transitory computer-readable medium described herein, the one or more selected parameter values may be selected in response to radio link control (RLC) establishment, an RLC update, a handover, a secondary cell (SCell) addition, or any combination thereof.

In some examples of the method, UEs, and non-transitory computer-readable medium described herein, the one or more selected parameter values may be associated with one or more parameters and the one or more selected parameter values for the one or more parameters may be smaller than one or more configured parameter values indicated to the UE for the same one or more parameters.

In some examples of the method, UEs, and non-transitory computer-readable medium described herein, operations, features, means, or instructions for selecting the one or more characteristics of the RLF procedure may include operations, features, means, or instructions for selecting one or more actions to be performed by the UE in response to a prediction of an RLF, a detection of the RLF, or both, where performing the RLF procedure includes performing the one or more actions performed in response to the prediction of the RLF, the detection of the RLF, or both.

In some examples of the method, UEs, and non-transitory computer-readable medium described herein, operations, features, means, or instructions for performing the RLF procedure in accordance with the one or more selected characteristics may include operations, features, means, or instructions for transmitting a message indicative of the RLF in response to the prediction of the RLF, the detection of the RLF, or both, where the one or more actions includes transmission of the message, and where the prediction of the RLF, the detection of the RLF, or both, may be in accordance with detection of a threshold quantity of retransmissions.

In some examples of the method, UEs, and non-transitory computer-readable medium described herein, operations, features, means, or instructions for performing the RLF procedure in accordance with the one or more selected characteristics may include operations, features, means, or instructions for transmitting an indication of the prediction of the RLF in response to the prediction of the RLF, where the one or more actions includes transmission of the indication.

In some examples of the method, UEs, and non-transitory computer-readable medium described herein, the indication of the prediction of the RLF includes an indication of a threshold quantity of retransmissions detected by the UE.

In some examples of the method, UEs, and non-transitory computer-readable medium described herein, operations, features, means, or instructions for performing the RLF procedure in accordance with the one or more selected characteristics may include operations, features, means, or instructions for transmitting a measurement report in response to the prediction of the RLF, the detection of the RLF, or both, where the one or more actions includes transmission of the measurement report.

In some examples of the method, UEs, and non-transitory computer-readable medium described herein, operations, features, means, or instructions for performing the RLF procedure in accordance with the one or more selected characteristics may include operations, features, means, or instructions for suspending the first communication link in response to the prediction of the RLF or the detection of the RLF, where the first communication link may be associated with the RLF, and where the one or more actions includes suspension of the first communication link.

Some examples of the method, UEs, and non-transitory computer-readable medium described herein may further include operations, features, means, or instructions for transmitting, via the second communication link and in response to suspension of the first communication link, an indication of the prediction of the RLF associated with the first communication link or an indication of the detection of the RLF associated with the first communication link.

Some examples of the method, UEs, and non-transitory computer-readable medium described herein may further include operations, features, means, or instructions for inputting one or more features associated with RLF into an ML model configured to predict an RLF, where performance of the RLF procedure includes prediction of the RLF in accordance with an output of the ML model.

In some examples of the method, UEs, and non-transitory computer-readable medium described herein, the one or more features include a quantity of bytes, one or more block error rates, one or more retransmission timers, one or more channel metrics, one or more parameters associated with a discontinuous reception cycle, a quantity of scheduling request failures, a quantity of control message failures, a quantity of data radio bearers, one or more transmission states of the UE, one or more thermal mitigation triggers, one or more conditions associated with one or more neighboring network entities, or any combination thereof.

Some examples of the method, UEs, and non-transitory computer-readable medium described herein may further include operations, features, means, or instructions for transmitting a capability message indicative of a capability of the UE to predict the RLF, where inputting the one or more features into the ML model may be in accordance with the capability of the UE.

Some examples of the method, UEs, and non-transitory computer-readable medium described herein may further include operations, features, means, or instructions for receiving a control message indicative of one or more model parameters associated with the ML model, where inputting the one or more features into the ML model may be in accordance with the one or more model parameters.

Some examples of the method, UEs, and non-transitory computer-readable medium described herein may further include operations, features, means, or instructions for storing an indication of the one or more selected characteristics of the RLF procedure, where the one or more selected characteristics include one or more parameter values associated with prediction of an RLF, one or more first actions performed by the UE in response to a prediction of the RLF, one or more second actions performed by the UE in response to a detection of the RLF, a quantity of retransmissions associated with the prediction of the RLF or the detection of the RLF, or any combination thereof.

In some examples of the method, UEs, and non-transitory computer-readable medium described herein, the configuration information may be further indicative of a threshold performance metric associated with prediction of RLF, one or more fallback procedures associated with failing to satisfy the threshold performance metric, or both.

Some examples of the method, UEs, and non-transitory computer-readable medium described herein may further include operations, features, means, or instructions for performing a second RLF procedure in accordance with one or more configured characteristics, rather than the one or more selected characteristics, based on a performance metric associated with the RLF procedure failing to satisfy the threshold performance metric.

Some examples of the method, UEs, and non-transitory computer-readable medium described herein may further include operations, features, means, or instructions for transmitting a report indicative of a performance metric associated with the RLF procedure failing to satisfy the threshold performance metric and disabling the selection of the one or more characteristics of the RLF procedure based on a performance metric associated with the RLF procedure failing to satisfy the threshold performance metric.

In some examples of the method, UEs, and non-transitory computer-readable medium described herein, operations, features, means, or instructions for obtaining the configuration information may include operations, features, means, or instructions for receiving, from a network entity, a control message indicative of the configuration information that enables the UE to autonomously select one or more characteristics of the RLF procedure, wherein selection of the one or more characteristics is based at least in part on reception of the control message.

A method for wireless communications by a network entity is described. The method may include transmitting a first control message including configuration information that enables a UE to select one or more characteristics of a RLF procedure and receiving, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

A network entity for wireless communications is described. The network entity may include one or more memories storing processor executable code, and one or more processors coupled with the one or more memories. The one or more processors may individually or collectively be operable to execute the code to cause the network entity to transmit a first control message including configuration information that enables a UE to select one or more characteristics of a RLF procedure and receive, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

Another network entity for wireless communications is described. The network entity may include means for transmitting a first control message including configuration information that enables a UE to select one or more characteristics of a RLF procedure and means for receiving, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

A non-transitory computer-readable medium storing code for wireless communications is described. The code may include instructions executable by one or more processors to transmit a first control message including configuration information that enables a UE to select one or more characteristics of a RLF procedure and receive, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

In some examples of the method, network entities, and non-transitory computer-readable medium described herein, the configuration information may be indicative of one or more ranges of parameter values associated with the prediction of the RLF and the method, apparatuses, and non-transitory computer-readable medium may include further operations, features, means, or instructions for receiving a third control message indicative of one or more parameter values selected by the UE from the one or more ranges of parameter values, where the prediction of the RLF, the detection of RLF at the UE, or both, may be in accordance with the one or more selected parameter values.

In some examples of the method, network entities, and non-transitory computer-readable medium described herein, the one or more selected parameter values includes a first threshold quantity of retransmissions that results in transmission of an RLF report, a second threshold quantity of retransmissions that results in the prediction of the RLF, or both.

In some examples of the method, network entities, and non-transitory computer-readable medium described herein, reception of the third control message may be in response to radio link control establishment, a radio link control update, a handover, a secondary cell addition, or any combination thereof.

In some examples of the method, network entities, and non-transitory computer-readable medium described herein, the one or more selected parameter values may be associated with one or more parameters and the one or more selected parameter values for the one or more parameters may be smaller than one or more configured parameter values indicated by the network entity for the same one or more parameters.

In some examples of the method, network entities, and non-transitory computer-readable medium described herein, operations, features, means, or instructions for receiving the indication of the prediction of the RLF, the detection of the RLF at the UE, or both may include operations, features, means, or instructions for receiving a message indicative of the RLF.

In some examples of the method, network entities, and non-transitory computer-readable medium described herein, operations, features, means, or instructions for receiving the indication of the prediction of the RLF, the detection of the RLF at the UE, or both may include operations, features, means, or instructions for receiving the indication of the prediction of the RLF, where the indication of the prediction of the RLF includes an indication of a threshold quantity of retransmissions detected by the UE.

In some examples of the method, network entities, and non-transitory computer-readable medium described herein, operations, features, means, or instructions for receiving the indication of the prediction of the RLF, the detection of the RLF at the UE, or both may include operations, features, means, or instructions for receiving a measurement report in response to the prediction of the RLF, the detection of the RLF, or both.

In some examples of the method, network entities, and non-transitory computer-readable medium described herein, operations, features, means, or instructions for receiving the indication of the prediction of the RLF, the detection of the RLF at the UE, or both may include operations, features, means, or instructions for receiving, via the second communication link, an indication of the prediction of the RLF associated with the first communication link or an indication of the detection of the RLF associated with the first communication link.

Some examples of the method, network entities, and non-transitory computer-readable medium described herein may further include operations, features, means, or instructions for receiving a capability message indicative of a capability of the UE to predict the RLF, where transmission of the first control message may be in response to reception of the capability message.

Some examples of the method, network entities, and non-transitory computer-readable medium described herein may further include operations, features, means, or instructions for transmitting a third message indicative of one or more model parameters associated with an ML model, where the one or more model parameters may be associated with the prediction of the RLF, the detection of the RLF at the UE, or both.

In some examples of the method, network entities, and non-transitory computer-readable medium described herein, the configuration information may be further indicative of a threshold performance metric associated with prediction of RLF, one or more fallback procedures associated with failing to satisfy the threshold performance metric, or both.

Some examples of the method, network entities, and non-transitory computer-readable medium described herein may further include operations, features, means, or instructions for receiving a report indicative of a performance metric associated with the RLF procedure failing to satisfy the threshold performance metric.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports radio link control (RLC) service interruption reduction for wireless communications in accordance with one or more aspects of the present disclosure.

FIG. 2 shows an example of a wireless communications system that supports RLC service interruption reduction for wireless communications in accordance with one or more aspects of the present disclosure.

FIGS. 3A, 3B, and 3C each show an example of a process flow that supports RLC service interruption reduction for wireless communications in accordance with one or more aspects of the present disclosure.

FIG. 4 shows an example of a machine learning (ML) architecture that supports RLC service interruption reduction for wireless communications in accordance with one or more aspects of the present disclosure.

FIG. 5 shows an example of a process flow that supports RLC service interruption reduction for wireless communications in accordance with one or more aspects of the present disclosure.

FIGS. 6 and 7 show block diagrams of devices that support RLC service interruption reduction for wireless communications in accordance with one or more aspects of the present disclosure.

FIG. 8 shows a block diagram of a communications manager that supports RLC service interruption reduction for wireless communications in accordance with one or more aspects of the present disclosure.

FIG. 9 shows a diagram of a system including a device that supports RLC service interruption reduction for wireless communications in accordance with one or more aspects of the present disclosure.

FIGS. 10 and 11 show block diagrams of devices that support RLC service interruption reduction for wireless communications in accordance with one or more aspects of the present disclosure.

FIG. 12 shows a block diagram of a communications manager that supports RLC service interruption reduction for wireless communications in accordance with one or more aspects of the present disclosure.

FIG. 13 shows a diagram of a system including a device that supports RLC service interruption reduction for wireless communications in accordance with one or more aspects of the present disclosure.

FIGS. 14 and 15 show flowcharts illustrating methods that support RLC service interruption reduction for wireless communications in accordance with one or more aspects of the present disclosure.

### DETAILED DESCRIPTION

In some wireless communications systems, such as a wireless communications system that supports radio link control (RLC) acknowledgment mode (AM), a user equipment (UE) may support radio link failure (RLF) detection and declaration. In such cases, the UE may monitor a quantity of retransmissions relative to a threshold quantity (e.g., maxRetxThreshold) such that when the quantity of retransmissions exceeds the threshold quantity, the UE may declare RLF. However, in some cases, the UE may be associated with a slow reaction time due to counting of the quantity of retransmissions. In other words, a first time at which the quantity of retransmissions actually exceeds the threshold quantity may occur before a second time at which the UE detects that the quantity of retransmissions has exceeded the threshold quantity due to a rate at which the UE counts the retransmissions, such that the UE may waste resources and power attempting to communicate retransmissions during a duration between the first time (e.g., when RLF occurs) and the second time (e.g., when RLF is detected), which may be referred to as interruption time. Additionally, or alternatively, counting a single packet data unit (PDU) retransmission for a large transmission window (e.g., transmission window exceeding a threshold size) may further slow the reaction time of the UE.

Accordingly, techniques described herein may enable a UE to autonomously select one or more characteristics of an RLF procedure to reduce the interruption time (e.g., between RLF occurrence and RLF detection, RLF resolution, or both). For example, the UE may autonomously select (e.g., using a machine learning (ML) model) one or more threshold quantities of retransmissions associated with prediction of RLF, detection of RLF, reporting of RLF, or any combination thereof. For example, the UE may receive, from a network entity, a control message indicating a first threshold quantity of retransmissions associated with declaration of RLF. Additionally, the UE may select a second threshold quantity of retransmissions associated with prediction of RLF, where the second threshold quantity of retransmissions is less than the first threshold quantity of retransmissions. Thus, the UE may predict an RLF, based on a counted quantity of retransmissions exceeding the second threshold quantity of retransmissions, before the RLF occurs (e.g., before the counted quantity of retransmissions exceeds the first threshold quantity of retransmissions), such that the UE, the network entity, or both, may initiate one or more actions to resolve the RLF before the RLF occurs, reducing the interruption time.

Additionally, or alternatively, the UE may autonomously select (e.g., using the ML model or a different ML model) one or more actions to be performed (e.g., initiated) based on prediction of an RLF (e.g., reaching the second quantity of threshold retransmissions). For example, in some cases, the UE may transmit an indication of early RLF (e.g., declare RLF before the RLF occurs), may transmit an indication that RLF is predicted, may transmit a measurement report, or any combination thereof, based on the counted quantity of retransmissions exceeding the second threshold quantity of retransmissions (e.g., RLF being predicted). Additionally, or alternatively, in some examples, such as when the UE supports multiple communication links (e.g., dual connectivity), the UE may suspend a first communication link based on the counted quantity of retransmissions exceeding the second threshold quantity of retransmissions on the first communication link and may transmit, on a second communication link, an indication of the suspension of the first communication link.

Aspects of the disclosure are initially described in the context of wireless communications systems. Aspects of the disclosure are then described in the context of process flows and an ML architecture. Aspects of the disclosure are further illustrated by and described with reference to apparatus diagrams, system diagrams, and flowcharts that relate to RLC service interruption reduction for wireless communications.

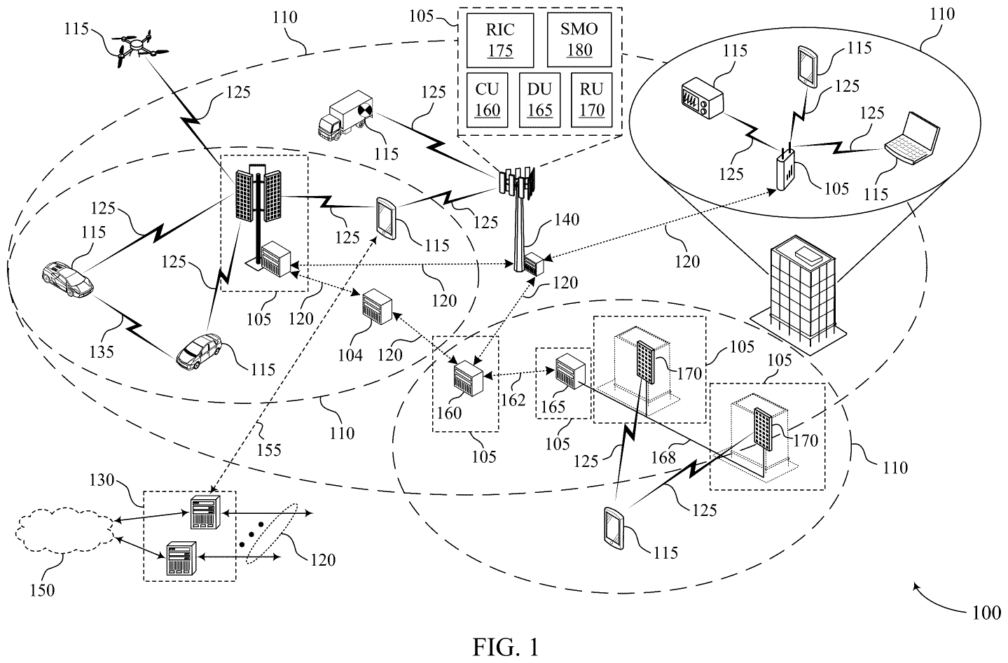

FIG. 1 shows an example of a wireless communications system 100 that supports RLC service interruption reduction for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., RLC (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the wireless communications system 100 may support techniques to enable a UE 115 to autonomously select one or more characteristics of an RLF procedure to reduce interruption time (e.g., between RLF occurrence and RLF detection, RLF resolution, or both). For example, the UE 115 may autonomously select (e.g., using an ML model) one or more threshold quantities of retransmissions associated with prediction of RLF, detection of RLF, reporting of RLF, or any combination thereof. That is, the UE 115 may receive, from a network entity 105, a control message indicating a first threshold quantity of retransmissions associated with declaration of RLF. Additionally, the UE 115 may select a second threshold quantity of retransmissions associated with prediction of RLF, where the second threshold quantity of retransmissions is less than the first threshold quantity of retransmissions. Thus, the UE 115 may predict an RLF, based on a counted quantity of retransmissions exceeding the second threshold quantity of retransmissions, before the RLF occurs (e.g., before the counted quantity of retransmissions exceeds the first threshold quantity of retransmissions), such that the UE 115, the network entity 105, or both, may initiate one or more actions to resolve the RLF before the RLF occurs, reducing the interruption time.

Additionally, or alternatively, the UE 115 may autonomously select (e.g., using the ML model) one or more actions to be performed (e.g., initiated) based on prediction of an RLF (e.g. reaching the second quantity of threshold retransmissions). For example, in some cases, the UE 115 may transmit an indication of early RLF (e.g., declare RLF before the RLF occurs), may transmit an indication that RLF is predicted, may transmit a measurement report, or any combination thereof, based on the counted quantity of retransmissions exceeding the second threshold quantity of retransmissions (e.g., RLF being predicted). Additionally, or alternatively, in some examples, such as when the UE 115 supports multiple communication links (e.g., dual connectivity), the UE 115 may suspend a first communication link based on the counted quantity of retransmissions exceeding the second threshold quantity of retransmissions on the first communication link and may transmit, on a second communication link, an indication of the suspension of the first communication link.

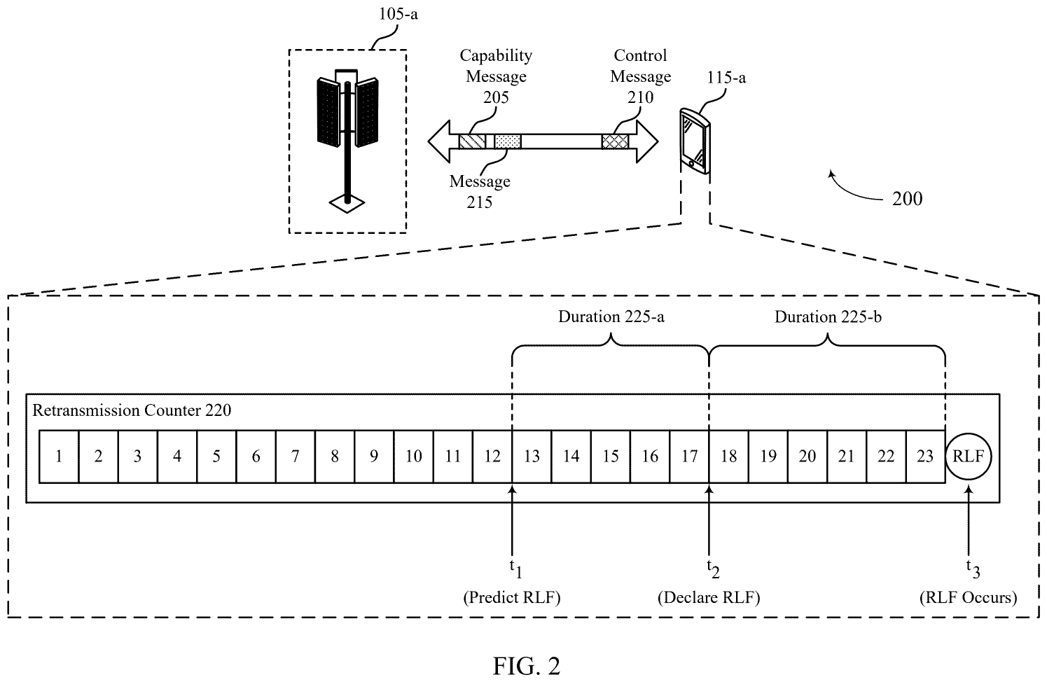

FIG. 2 shows an example of a wireless communications system 200 that supports RLC service interruption reduction for wireless communications in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

Some wireless communications systems, such as the wireless communications system 200, may support detection and declaration of RLF (e.g., at RLC AM) to indicate that a radio channel cannot support a reliability threshold (e.g., target) associated with (e.g., required by) an application. To do so (e.g., in 5G), a wireless device, such as the UE 115-a, may measure (e.g., count) a quantity of retransmissions for each PDU (e.g., using a retransmission counter 220, RETX_COUNT) and may declare RLF based on the quantity of retransmissions (e.g., a value of the retransmission counter 220) meeting or exceeding (e.g., reaching) a threshold quantity of retransmissions. (e.g., RETX_COUNT=maxRetxThreshold). In such cases, the UE 115-a may retransmit a PDU based on receiving an indication of a NACK associated with the PDU (e.g., in a status report), based on an empty buffer from a new PDU, based on an empty buffer from the PDU associated with the NACK, based on expiration of a retransmission timer (e.g., t-PollRetransmit), or any combination thereof.

However, in some cases, the UE 115-a may be associated with a slow reaction time due to counting the quantity of retransmissions for each PDU to the threshold quantity of retransmissions. In other words, a first time at which the counted quantity of retransmissions actually exceeds the threshold quantity of retransmissions may occur before a second time at which the UE 115-a detects (e.g., counts) that the quantity of retransmissions has exceeded the threshold quantity due to a rate at which the UE 115-a counts the retransmissions. Thus, the UE 115-a may waste resources and power attempting to communicate retransmissions during a duration between the first time (e.g., when RLF occurs) and the second time (e.g., when RLF is detected), which may be referred to as interruption time (e.g., interruption duration).

For example (e.g., for a bad radio channel), multiple PDUs may be retransmitted (e.g., by the UE 115-a) due to STATUS PDUs associated with the multiple PDUs (e.g., multiple indicators of statuses of the multiple PDUs) indicating a negative acknowledgment (NACK) for the multiple PDUs (e.g., lost PDUs). Additionally, the UE 115-a may be associated with a 40 ms poll time (e.g., count time) and the threshold quantity of transmissions may be set to a value of 32. Thus, an interruption time (e.g., minimum interruption time) before RLF is declared by the UE 115-a may be equal to 1.3 seconds (e.g., 40 ms×32=1.3 ms). Thus, the 1.3 seconds (e.g., at least the minimum interruption time) may be associated with wasted power by the UE 115-a due to continuing to perform retransmissions (e.g., on the bad channel) and delay in declaring RLF. The interruption time may further be added to a duration associated with re-establishment after RLF (e.g., RRC Reestablishment time), resulting in a service interruption time exceeding a threshold service interruption time (e.g., resulting in a very long service interruption time).

Additionally, or alternatively, the UE 115-a counting a single PDU transmission for a threshold transmission window (e.g., large transmission window) may be slow (e.g., below a threshold speed), particularly when a network entity 105, such as the network entity 105-a, does not acknowledge (e.g., ignores) polling by the UE 115-a, a STATUS PDU is lost, or both. That is, since a PDU is retransmitted (e.g., by the UE 115-a) based on reception of a NACK associated with the PDU or based on a retransmission timer (e.g., t-PollRetransmit) expiring, multiple PDUs may be unsuccessfully transmitted simultaneously, which may increase interruption time. In other words, a retransmission counter 220 of a single service data unit (SDU) may be an inaccurate measure of radio channel degradation due to the retransmission counter for the single SDU not moving until after a retransmission of the SDU, such that each retransmission may occur based on reception of a NACK associated with a PDU or based on a retransmission timer (e.g., t-PollRetransmit) expiring. For example, the UE 115-a may poll a latest sequence number (SN) in arriving data to identify a latest PDU, thus, if the network entity 105-a stops sending STATUS PDUs, the UE 115-a may continue to poll new data without retransmissions of any PDU reaching the threshold quantity of retransmissions, resulting in interruption of service and increases UE power consumption. In such cases, the UE 115-a (e.g., a queue at the UE 115-a) may identify PDUs according to a SN allocated by an RLC entity.

Accordingly, techniques described herein may enable the UE 115-a to autonomously select (e.g., using an ML model) one or more characteristics of an RLF procedure to reduce interruption time (e.g., between RLF occurrence and RLF detection, RLF resolution, or both). For example, the UE 115-a may transmit a capability message 205 indicating a capability of the UE 115-a to support autonomous selection, by the UE, of the one or more characteristics of the RLF procedure. In some cases, the network entity 105-a may transmit a control message 210 (e.g., responsive to the capability message 205) enabling the autonomous selection by the UE 115-a (e.g., including configuration information that enables the autonomous selection). Additionally, or alternatively, the UE 115-a may obtain the configuration information that enables the autonomous selection from a higher layer (e.g., upper layer) of the UE 115-a, such as an RRC layer, a MAC layer, an RLC layer, or any combination thereof.

In some cases, enabling the autonomous selection by the UE 115-a may restrict selection of the one or more characteristics of the RLF procedure by the network entity 105-a. That is, the network entity 105-a may be restricted from selecting the one or more characteristics of the RLF procedure for the UE 115-a, the UE 115-a may disregard (e.g., override, ignore) the one or more characteristics of the RLF procedure selected by the network entity 105-a, or both, based on the autonomous selection being enabled at the UE 115-a.

In some cases, the one or more characteristics of the RLF procedure may include one or more values of one or more thresholds associated with prediction of an RLF, detection of the RLF, reporting of the RLF, or any combination thereof. For example, the control message 210 (e.g., or another control message 210) may indicate a first value of maxRetxThresholdRLF (e.g., a first threshold quantity of retransmissions associated with detection of RLF), a second value of maxRetxThresholdReport (e.g., a second threshold quantity of retransmissions associated with transmission of an RLF report), or both. However, the UE 115-a may select (e.g., predict) a third value of maxRetxThresholdRLF, a fourth value of maxRetxThresholdReport, or both, and may count retransmissions in accordance with the third value and the fourth value (e.g., rather than the first value and the second value). In such cases, the third value may be less than the first value, the fourth value may be less than the second value, or both, such that the UE 115-a may predict RLF prior to RLF occurring. That is, the first value and the second value may be associated with an actual instance at which RLF occurs, while the third value and the fourth value may be associated with an instance at which RLF is predicted (e.g., an instance at which the UE 115-a identifies that RLF is likely to occur). Thus, the UE 115-a may initiate (e.g., perform) one or more actions to reduce interruption time (e.g., based on receiving the control message 210 enabling the autonomous selection by the UE 115-a) based on predicting RLF in accordance with the third value of maxRetxThresholdRLF, the fourth value of maxRetxThresholdReport, or both.

For example, the UE 115-a may receive, from the network entity 105-a, a control message 210 indicative of a maxRetxThresholdRLF of 23. However, the UE 115-a may select a new value for the maxRetxThresholdRLF of 17 and may select a value of earlyRLFRetxThreshold (e.g., early_rlf_retx_cnt, a third threshold quantity of retransmissions associated with detection of early RLF/prediction of RLF) of 12. In other words, the control message 210 may indicate to the UE 115-a that an RLF occurs based on a retransmission counter 220 reaching a count of 23 (e.g., at time t₃). However, the UE 115-a may determine (e.g., using the ML model) that if the retransmission counter 220 reaches a count of at least 12 (e.g., at time t₁), there is a threshold probability (e.g., high likelihood) that the RLF will occur (e.g., at time t₃), such that the UE 115-a may enter a mitigation phase to attempt to mitigate the predicted RLF over a duration 225-a (e.g., 200 ms).

The UE 115-a may additionally determine (e.g., using the ML model) that if mitigation of the predicted RLF is not complete prior to the retransmission counter 220 reaching a count of 17 (e.g., the predicted RLF is not mitigated by time t₂), then the UE 115-a may declare early RLF (e.g., mitigation is unlikely to be successful). For example, if the UE 115-a does not receive a handover message, if the UE 115-a does not receive a STATUS PDU (e.g., RLC STATUS PDU), or both, prior to the retransmission counter 220 reaching a count of 17, then the UE 115-a may declare early RLF (e.g., at time t₂). In other words, the UE 115-a may declare early RLF a duration 225-b (e.g., 240 ms) prior the RLF occurring (e.g., when the retransmission counter 220 reaching the count of 23). Thus, if the UE 115-a is associated with a 40 ms poll time (e.g., an early RLF timer is 40 ms), then the UE 115-a may reduce an interruption time (e.g., and improve an overall modem key performance indicator (KPI), improve a data resumption delay) by 440 ms based on predicting the RLF based on the retransmission counter 220 reaching the count of 12 (e.g., a sum of the duration 225-a and the duration 225-b prior to RLF occurring).

In some cases, the one or more values of one or more thresholds selected by the UE 115-a may be semi-static. That is, the UE 115-a may select the one or more values during RLC establishment and may update the one or more values after any combination of a handover, after a secondary cell (SCell) addition, or the like thereof. Additionally, or alternatively, the one or more values selected by the UE 115-a may be dynamic based on one or more dynamic parameters, such as any combination of one or more measurements by the UE 115-a (e.g., L1 measurements), a power level of the UE 115-a, a memory consumption of the UE 115-a, or the like thereof (e.g., in such cases, a state may map into an action without immediate thresholds). Additionally, or alternatively, the UE 115-a may transmit (e.g., dynamically, continuously, occasionally, periodically) a message 215 (e.g., RRC signaling, RLC signaling, MAC-CE signaling) reporting the one or more values selected by the UE 115-a.

Additionally, or alternatively, the one or more characteristics of the RLF procedure may include one or more actions performed by the UE 115-a based on prediction of RLF (e.g., based on reaching the one or more threshold quantities of retransmissions selected by the UE 115-a using the ML model). In some cases, one or more actions may include the UE 115-a declaring early RLF. That is, as discussed above, the UE 115-a may receive an indication of the first value of maxRetxThresholdRLF from the network entity 105-a and may determine (e.g., select, derive) the third value of maxRetxThresholdRLF, where the third value is less than the first value. Thus, if the retransmission counter 220 reaches the third value, the UE 115-a may declare RLF (e.g., transmit a message 215 indicating early RLF) to reduce service interruption.

Additionally, or alternatively, the one or more actions may include the UE 115-a indicating, to the network entity 105-a (e.g., via a message 215) that RLF is predicted (e.g., transmitting an early RLF report). That is, as discussed above, the UE 115-a may determine a fifth value of earlyRLFRetxThreshold and may transmit an early RLF report (e.g., via a message 215) indicating that a quantity of retransmissions equal to the fifth value has been reached, RLF is predicted, or both, based on the retransmission counter 220 reaching the fifth value of earlyRLFRetxThreshold. Thus, as discussed above, the network entity 105-a may initiate a handover, perform early RLF recovery, or both, based on receiving the report (e.g., resulting in an interruption of ˜50 ms rather than multiple seconds).

Additionally, or alternatively, the one or more actions may include the UE 115-a transmitting, to the network entity 105-a (e.g., via a message 215), a measurement report. That is, the UE 115-a may transmit the measurement report based on the retransmission counter 220 reaching the fifth value of earlyRLFRetxThreshold, the third value (e.g., UE-derived) of maxRetxThresholdRLF, or both. Thus, as discussed above, the network entity 105-a may initiate a handover, perform early RLF recovery, or both, based on receiving the measurement report. Additionally, or alternatively, in some cases, the UE 115-a may support multiple communication links (E.g., dual connectivity), such as a first communication link and a second communication link. In such cases, the UE 115-a may suspend the first communication link based on a retransmission counter 220 associated with the first communication link reaching the fifth value of earlyRLFRetxThreshold, the third value (e.g., UE-derived) of maxRetxThresholdRLF, or both. Additionally, the UE 115-a may transmit, via the second communication link, an indication of the suspension of the first communication link (e.g., RLF detection or prediction on the first communication link), such that the network entity 105-a may initiate master cell group (MCG) failure reporting, secondary cell group (SCG) failure reporting, or both (e.g., and fast recover).

In some cases, the UE 115-a may use an ML model (e.g., artificial intelligence (AI) model) to select the one or more characteristics associated with the RLF procedure (e.g., the one or more values of the one or more thresholds, the one or more actions to be performed by the UE 115-a, or both). That is, the UE 115-a may input one or more features into the ML model and the ML model may output an indication of the one or more characteristics associated with the RLF procedure. For example, the ML model may output (e.g., predict with high accuracy) the third value of maxRetxThresholdRLF, the fourth value of maxRetxThresholdReport, the fifth value of earlyRLFRetxThreshold, or any combination thereof.

In such cases, the one or more features may include an outstanding quantity of bytes in tx_win to be acknowledged (e.g., tx_win_bytes), an uplink HARQ block error rate (BLER) (e.g., harqbler_ul), a downlink HARQ BLER (e.g., harqbler_dl), a poll retransmission timer configured by the network entity 105-a (e.g., poll_retx_timer), an early RLF retransmission timer (e.g., early_retx_timer), a quantity of retx_count of tx_next_ack (e.g., tx_next_ack_retx_count), a downlink RLC BLER (e.g., rlc_bler_dl), an uplink RLC BLER (e.g., rlc_bler_ul), or any combination thereof. Additionally, or alternatively, the one or more features may include one or more historical (e.g., past) values the outstanding quantity of bytes in tx_win to be acknowledged, the uplink HARQ BLER, the downlink HARQ BLER, the downlink RLC BLER, the uplink RLC BLER, or any combination thereof.

Additionally, or alternatively, the one or more features may include one or more physical channel conditions (e.g., reference signal receive power (RSRP), reference signal receive quality (RSRQ), signal to noise ratio (SNR), or the like thereof) measured by the UE 115-a, a discontinuous reception (DRX) cycle configuration, a quantity of scheduling request (SR) failures, a quantity of control message (e.g., DCI) failures, a quantity of data radio bearers (DRBs), a transmission state of the UE 115-a, one or more thermal mitigation triggers, or any combination thereof. Additionally, or alternatively, in some cases, the one or more features may further include one or more neighbor network entities 105 (e.g., cells) radio conditions to enable the ML model (e.g., the UE 115-a) to select between declaring early RLF or attempting to initiate a handover by transmitting an early RLF report to the network entity 105-a. In some cases, the UE 115-a may transmit an indication of an accuracy associated with the ML model (e.g., in terms of performance) to the network entity 105-a via the capability message 205.

In some examples, the UE 115-a, the network entity 105-a, a model repository (MR) (e.g., ML server associated with the UE 115-a, the network entity 105-a, or both), or any combination thereof, may collect data (e.g., information elements (IEs), meta data, timestamps, labels, etc.) associated with the ML model. Generally, the ML model may predict the RLF before RLF occurs (e.g., according to the first value of maxRetxThresholdRLF configured by the network entity 105-a). Thus, the ML model may consider a tradeoff between interruption time saved and a probability of unnecessary RLF (e.g., the UE 115-a declares RLF according to the one or more characteristics output by the ML model but not according to the first value of maxRetxThresholdRLF configured by the network entity 105-a). In other words, the ML model may balance additional reporting by the UE 115-a (e.g., according to maxRetxThresholdReport) and reduction of interruption time.

Thus, data collection by the UE 115-a, the network entity 105-a, the MR, or any combination thereof, may enable the wireless communications system 200 to train (e.g., build) the ML model and improve both an accuracy of the ML model and a balance of the tradeoffs. As such, the UE 115-a may log (e.g., store) and report to the network entity 105-a any combination of: a history of the one or more actions performed by the UE 115-a (e.g., early RLFs declared, early RLF reports transmitted, or both, based on the ML model predicting RLF), the one or more values of the one or more threshold quantities predicted by the ML model (e.g., maxRetxThresholdRLF, maxRetxThresholdReport, or any other predictive service interruption minimization criteria), the one or more features input into the model, a history of retransmission counts across an RLC entity (e.g., to assess underprediction), or the like thereof.

In some cases, the network entity 105-a may indicate (e.g., configured) one or more parameters associated with the ML model in terms of a range of values (e.g., configurations), a range of performance targets, or both, to enable the UE 115-a to apply the ML model to predict the third value of maxRetxThresholdRLF, the fourth value of maxRetxThresholdReport, the fifth value of earlyRLFRetxThreshold, or any combination thereof. In such cases, the one or more parameters may be indicated per-SDU or per-window (e.g., a new measure based on a transmission window). For example, the network entity 105-a may transmit, to the UE 115-a, configuration information indicated in Table 1, below, where the one or more parameters indicated in the configuration information are defined in Table 2, below.

TABLE 1
Configuration Information

| | |
|---|---|
| UL-AM-RLC ::= | SEQUENCE { |

```
  maxRetxThreshold ENUMERATED { t1, t2, t3, t4, t6, t8, t16, t32 }
  minRetxThresholdRLF ENUMERATED { }
  minRetxThresholdReport ENUMERATED { }
  maxRetxThresholdReport ENUMERATED { }
  Max-Interruption-time ENUMERATED { }
  Min-Interruption-time ENUMERATED { }
  Excessive-RLF-Count ENUMERATED { }
  Excessive-Report-Count ENUMERATED { }
```

| | |
|---|---|
| AIML-Early-RLF-allowed | BOOLEAN |
| AIML-Interruption-Report-allowed | BOOLEAN |
| AIML-Suspend-CG-allowed | BOOLEAN |
| QoSFlows/LCHAllowed | SEQUENCE {QoS/LCH |
| | flows indexes} |

TABLE 2
Parameter Definitions

| Parameter | Description |
|---|---|
| maxRetxThreshold | Per-SDU parameter for a quantity of |
| | retransmissions that lead to RLF (e.g., |
| | maximum value configured by the network |
| | entity 105-a). |
| minRetxThresholdRLF | Threshold (e.g., minimum) quantity of |
| | retransmissions (counter per-SDU or window |
| | based) that lead to RLF. |
| minRetxThresholdReport | First threshold (e.g., minimum) quantity of |
| | retransmissions (counter per-SDU or window |
| | based) that lead to early RLF report to |
| | initiate a handover. |
| maxRetxThresholdReport | Second threshold (e.g., maximum) quantity of |
| | retransmissions (counter per-SDU or window |
| | based) that lead to early RLF report to |
| | initiate a handover. |
| Max-Interruption-time | First performance target (e.g., KPI) set by |
| | the network entity 105-a for a threshold |
| | interruption time at RLC. This may be |
| | a function of quality of service. |
| Min-Interruption-time | Informs the UE 115-a of a threshold (e.g., |
| | minimum) interruption time. For example, the |
| | UE 115-a may not perform corrective actions |
| | if this time has not elapsed (e.g., since |
| | last Status report/Nacked PDU). |
| Excessive- | Second performance target (e.g., KPI) |
| RLF-Count | associated with excessive RLF by the UE 115-a |
| | (e.g. due to ML model underprediction). This |
| | may be a limit of RLFs the UE 115-a is |
| | allowed to declare early over a configured |
| | duration. |
| Excessive- | Third performance target (e.g., KPI) associated |
| Report-Count | with excessive reporting of service |
| | interruption. This may be based on counting |
| | reports that do not lead to handover, a RLF, |
| | or both. |
| AIML-Early- | An indication of whether the ML model is |
| RLF-allowed | enabled (e.g., allowed) for early RLF |
| AIML-Interruption- | An indication of whether the ML model is |
| Report-allowed | enabled (e.g., allowed) for interruption |
| | reporting. |
| AIML-Suspend- | An indication of whether the ML model is |
| CG-allowed | enabled (e.g., allowed) for suspending a cell |
| | group and sending a report on the other cell |
| | group in a dual connectivity deployment. This |
| | may be a part of a dual connectivity |
| | configuration. |
| QoSFlows/LCHAllowed | An indication of one or more quality of service |
| | flows, logical channel flows, or both, that |
| | support the ML model (e.g., ML model |
| | behavior is allowed on). |

In some cases, the network entity 105-a may indicate (e.g., configure), to the UE 115-a, one or more fallback procedures (e.g., behaviors) associated with the UE 115-a being unable to maintain (e.g., meet, satisfy) one or more threshold performance metrics, such as the first performance target, the second performance target, the third performance target, or any combination thereof (e.g., the UE 115-a may be transmitting early RLF reports, declaring early RLF, or both, at a frequency which degrades performance of the UE 115-a). For example, the one or more fallback procedures may include the UE 115-a falling back to performing RLF procedures without the assistance of the ML model (e.g., fallback to non-ML behavior for a define backoff), the UE 115-a transmitting, to the network entity 105-a (e.g., the MR, or both), a report (e.g., KPI violation report) indicating a violation of the one or more threshold performance metrics, the UE 115-a disabling the use of the ML model for RLC (e.g., for logical channels), or any combination thereof.

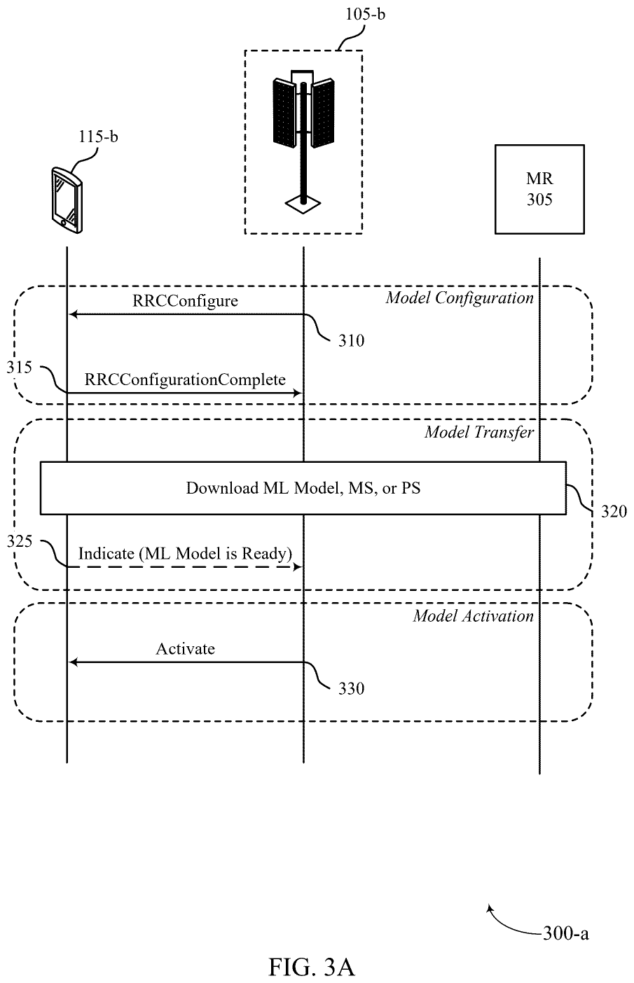

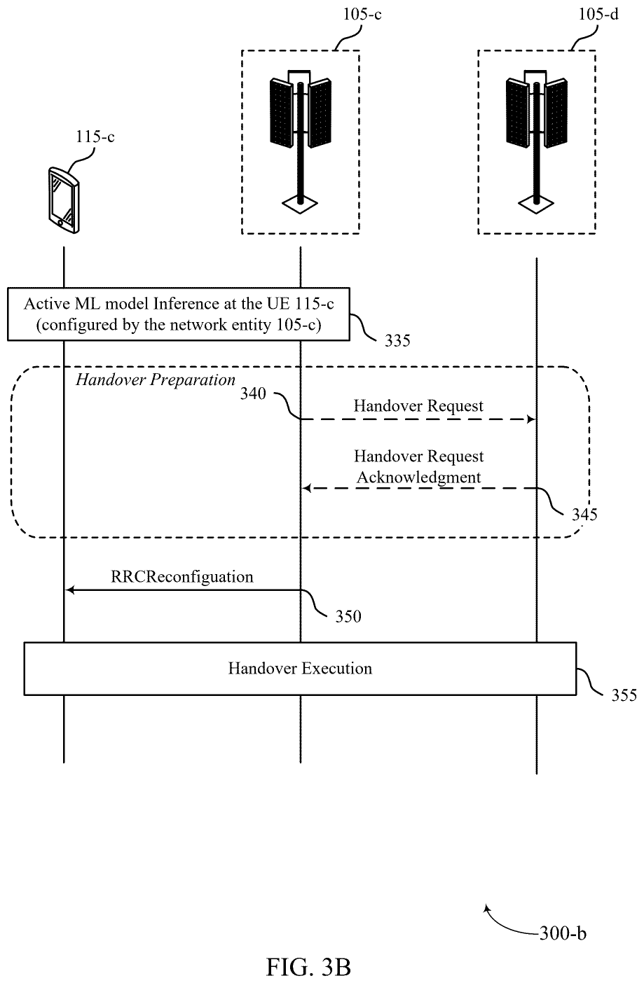

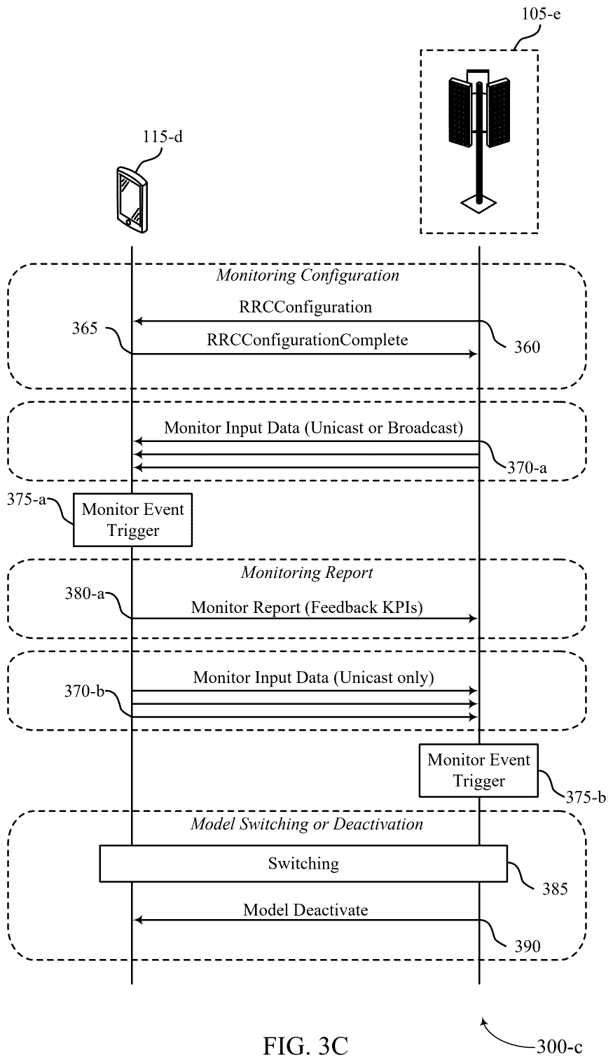

FIGS. 3A, 3B, and 3C each show an example of a process flow 300 (e.g., a process flow 300-a, a process flow 300-b, and a process flow 300-c) that supports RLC service interruption reduction for wireless communications in accordance with one or more aspects of the present disclosure. In some cases, the process flows 300 may implement or be implemented by aspects of the wireless communications system 100, the wireless communications system 200, or both. For example, the process flows 300 may include one or more UEs 115 (e.g., a UE 115-b, a UE 115-c, and a UE 115-d) and one or more network entities 105 (e.g., a network entity 105-b, a network entity 105-c, a network entity 105-d, and a network entity 105-e), which may be examples of the corresponding devices as described herein. In the following description of the process flows 300, the operations between the UEs 115 and the network entities 105 may be transmitted in a different order than the example order shown, or the operations performed by the UEs 115 and the network entities 105 may be performed in different orders or at different times. Some operations may also be omitted from the process flows 300, and other operations may be added to the process flows 300.

In some wireless communications systems, a network entity 105, such as the network entity 105-b, may configure and activate a ML model for inference, as described with reference to the process flow 300-a. For example, at 310, the network entity 105-b may transmit, to the UE 115-b, a control message indicative of configuration information (e.g., RRCConfigure) associated with a ML mode. In some cases, the configuration information may indicate one or more parameters associated with the ML model, as described with reference to FIG. 2. For example, the configuration information many indicate one or more model management parameters, one or more ML model input parameters (e.g., input data), one or more monitoring parameters (e.g., KPIs), or any combination thereof. The one or more model management parameters (e.g., model inference configuration) may include a ML model feature name (MLFN), a ML model identifier (ID), a model structure (MS) ID, a parameter set (e.g., absolute or delta), other configuration information (e.g., other RRC configurations, such as a measurement configuration, a MAC configuration, etc.), or any combination thereof. The one or more ML model input parameters may include data (e.g., meta-data) associated with (e.g., required for) model inference. The one or more monitoring parameters may include one or more monitoring input data parameters (e.g., meta-data associated with a model switch decision, ground truth data for model KPI evaluation), one or more monitoring report parameters (e.g., feedback KPIs, system KPIs, inference KPIs), one or more model switching events (e.g., reports based on monitoring), or any combination thereof.

Thus, at 315, the UE 115-b may transmit a responsive message indicating that the UE 115-a has configured the ML model in accordance with the configuration information (e.g., RRCConfigurationComplete).

In some cases, at 320, the UE 115-b, the network entity 105-b, or both, may downlink the ML model, a MS associated with the ML model (e.g., computational graph), a PS associated with the ML model (e.g., neural network weights), or any combination thereof, from a MR 305.

At 325, the UE 115-b may indicate, to the network entity 105-b, that the ML model is ready to be activated at the UE 115-b (e.g., downlink is complete), such that, at 330, the network entity 105-a may transmit a second control message (e.g., Layer 1 (L1)/Layer 2 (L2) indication, MAC-CE message) activating the ML model.

Additionally, or alternatively, some wireless communications systems may support a procedure for ML model mobility handling as part of a handover procedure, as described with reference to the process flow 300-b. For example, at 335, the UE 115-c may perform active ML model inference (e.g., configured by the network entity 105-c). In some cases, the active ML model inference may result in the UE 115-c predicting RLF and may entering a mitigation phase during which the UE 115-c and a network entity 105, such as the network entity 105-c, may initiate a handover procedure, as described with reference to FIG. 2

At 340, the network entity 105-c (e.g., source network entity 105) may transmit a handover request to the network entity 105-d (e.g., target network entity 105), where the handover request indicates ML model context for the UE 115-c.

Thus, at 345, the network entity 105-d may transmit a handover request acknowledgment in response to the handover request, where the handover request acknowledgment indicates a target ML model configuration for the UE 115-c to use during communications with the network entity 105-d. In such cases, the target ML model configuration may be based on the ML model context indicated in the handover request, one or more capabilities of the UE 115-c, one or more capabilities of the network entity 105-d, or any combination thereof. Additionally, or alternatively, the target ML model configuration may be indicated directly in the handover request acknowledgment (e.g., full target ML model configuration) or may be indicated as one or more deltas relative to a previous ML model configuration.

At 350, the network entity 105-c may transmit, to the UE 115-c, a third control message indicating the target ML model configuration (e.g., RRCReconfiguration) and the UE 115-c may update a current ML model configuration of the UE 115-c to the target ML model configuration (e.g., as part of a configuration update of the UE 15-c for the handover). Thus, at 355, the UE 115-c, the network entity 105-c, and the network entity 105-d may execute the handover.

Additionally, or alternatively, in some cases, a network entity 105, such as the network entity 105-e, may update (e.g., change, adapt) a ML model at a UE 115, such as the UE 115-d, based on reporting by the UE 115-d, monitoring by the network entity 105-e, or both, as described with reference to the process flow 300-c. For example, at 360, the UE 115-d may receive, from the network entity 105-e, a fourth control message indicating configuration information associated with the ML model (e.g., RRCConfiguration). In some cases (e.g., for updates based on reporting by the UE 115-d), the configuration information may indicate a list of performance KPIs, a list of system KPIs, one or more monitoring events (e.g., thresholds, environment of the UE 115-d), one or more reporting configurations (e.g., reporting events, reporting periodicity), or any combination thereof. In some other cases (e.g., for updates based on monitoring by the network entity 105-e), the configuration information may indicate a list of monitoring data (e.g., required for evaluating one or more feedback KPIs). In such cases, the one or more monitoring events may be determined by the network entity 105-e.

At 365, the UE 115-d may transmit a responsive message indicating that the UE 115-d has configured the ML model in accordance with the configuration information (e.g., RRCConfigurationComplete).

In some cases, to update the ML model based on reporting by the UE 115-d, at 370-a, the UE 115-d may monitor input data from the network entity 105-c (e.g., via unicast or broadcast). In such cases, the input data may include the list of monitoring data (e.g., required for evaluating one or more feedback KPIs), data (e.g., meta-data) for evaluating one or more switching conditions associated with the ML model, or both. Thus, at 375-a, the UE 115-d may monitor for one or more event triggers (e.g., one or more monitoring or reporting conditions) and, at 380-a, may transmit a monitor report based on detecting the one or more event triggers, where the monitor report indicates the one or more feedback KPIs.

Additionally, or alternatively, to update the ML model based on the monitoring by the network entity 105-e, at 370-b, the network entity 105-e may monitor input data from the UE 115-d (e.g., via unicast) and, at 375-b, may monitor for one or more event triggers.

In either case, at 385, the UE 115-d, the network entity 105-c, or both, may switch the ML model or, at 390, deactivate the ML model (e.g., via L3 reconfiguration or L2 activation). In some cases, the UE 115-d, the network entity 105-e, or both, may switch the ML model or deactivate the ML model based on the monitor report. For example, if the one or more feedback KPIs reported by the UE 115-d fall below a threshold, the network entity 105-e may transmit a sixth control message (e.g., RRCReconfiguration message for L3 or MAC-CE message for L2) to switch the ML model or deactivate the ML model. Additionally, or alternatively, the UE 115-d, the network entity 105-e, or both, may switch the ML model or deactivate the ML model based on the monitoring by the network entity 105-e. For example, if the one or more feedback KPIs evaluated by the network entity 105-e fall below the threshold, the network entity 105-e may transmit the sixth control message to switch the ML model or deactivate the ML model.

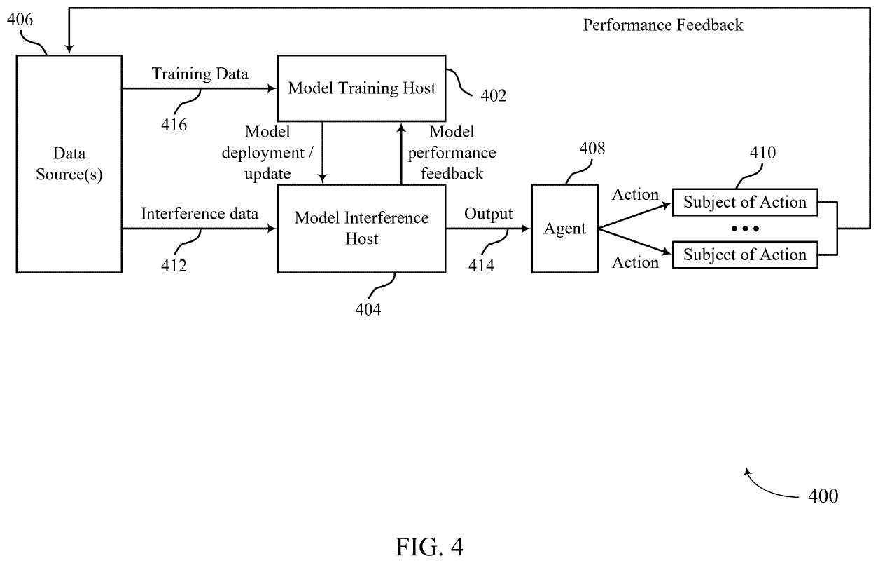

FIG. 4 is an illustrative block diagram of an example ML architecture 400 that supports RLC service interruption reduction for wireless communications in accordance with one or more aspects of the present disclosure. The ML architecture 400 may implement or be implemented by aspects of the wireless communications system 100, the wireless communications system 200, the process flows 300, or any combination thereof. For example, the ML architecture 400 may be implemented by one or more UEs 115 and one or more network entities 105, which may be examples of the corresponding devices as described herein.

The ML architecture 400 may be used for wireless communications in any of the various implementations, processes, environments, networks, or use cases described herein. As illustrated, ML architecture 400 includes multiple logical entities, such as a model training host 402, a model inference host 404, data source(s) 406, and an agent 408. The model inference host 404 may be configured to run an ML model based on inference data 412 provided by the data source(s) 406. The model inference host 404 (e.g., MR host) may produce an output 414, which may include a prediction or inference, such as a discrete or continuous value based on inference data 412, which may then be provided as an input to the agent 408.

The agent 408 may represent an element or an entity of a wireless communication system including, for example, a radio access network (RAN), a wireless local area network, a device-to-device (D2D) communications system, etc. As an example, the agent 408 may be a UE 115 (e.g., such as the UE 115-a, the UE 115-b, the UE 115-c, the UE 115-d, a UE 115-e, or any combination thereof), a network entity 105 (e.g., such as the network entity 105-a, the network entity 105-b, the network entity 105-c, the network entity 105-d, the network entity 105-e, a network entity 105-f, or any combination thereof), or a disaggregated network entity (e.g., such as a CU 160, a DU 165, an RU 170, an access point, a wireless station, an RIC 175 in a cloud-based RAN, among other examples). Additionally, the agent 408 also may be a type of agent that depends on the type of tasks performed by the model inference host 404, the type of inference data 412 provided to the model inference host 404, or the type of output 414 produced by the model inference host 404. For example, if output 414 from the model inference host 404 is associated with RLF prediction, the agent 408 may be or include a UE 115, a network entity 105, or both.

The agent 408 may perform one or more actions associated with receiving the output 414 from the model inference host 404. For example, if the agent 408 is a UE 115 and the output from the model inference host 404 is associated with RLF prediction, the agent 408 may autonomously select one or more characteristics of an RLF procedure to reduce interruption time based on the output from the model inference host 404. The agent 408 may indicate the one or more actions performed to at least one subject of action 410. For example, if the agent 408 autonomously select one or more characteristics of an RLF procedure, the agent 408 may transmit an indication of the one or more selected characteristics to the at least one subject of action 410. In some cases, the agent 408 and the subject of action 410 may be same entity.

Data can be collected from the data sources 406, and may be used as training data 416 for training an ML model, or as inference data 412 for feeding an ML model inference operation. The data sources 406 may collect data from various subject of action 410 entities (such as, the UE 115 or the network entity 105), and provide the collected data to the model training host 402 for ML model training. For example, after a subject of action 410 (such as, a network entity 105) receives an indication that RLF is predicted from the agent 408, the subject of action 410 may provide performance feedback associated with the RLF prediction to the data sources 406. The performance feedback may be used by the model training host 402 for monitoring or evaluating the ML model performance. In some examples, if the output 414 provided to the agent 408 is inaccurate (or the accuracy is below an accuracy threshold), the model training host 402 may provide feedback to the model inference host 404 to modify or retrain the ML model used by the model inference host 404, such as via an ML model deployment update.

The model training host 402 may be deployed at the same or a different entity than that in which the model inference host 404 is deployed. For example, in order to offload model training processing, which can impact the performance of the model inference host 404, the model training host 402 may be deployed at a model server.

In some aspects, an ML model may be deployed at or on a network entity 105 for RLF prediction (e.g., early RLF detection). More specifically, a model interference host, such as the model inference host 404 in FIG. 4, may be deployed at or on the network entity 105 for such RLF prediction. Additionally, or alternatively, the ML model may be deployed at or on a UE 115 for RLF prediction. More specifically, a model inference host, such as the model inference host 404 in FIG. 4, may be deployed at or on the UE 115 for RLF prediction.

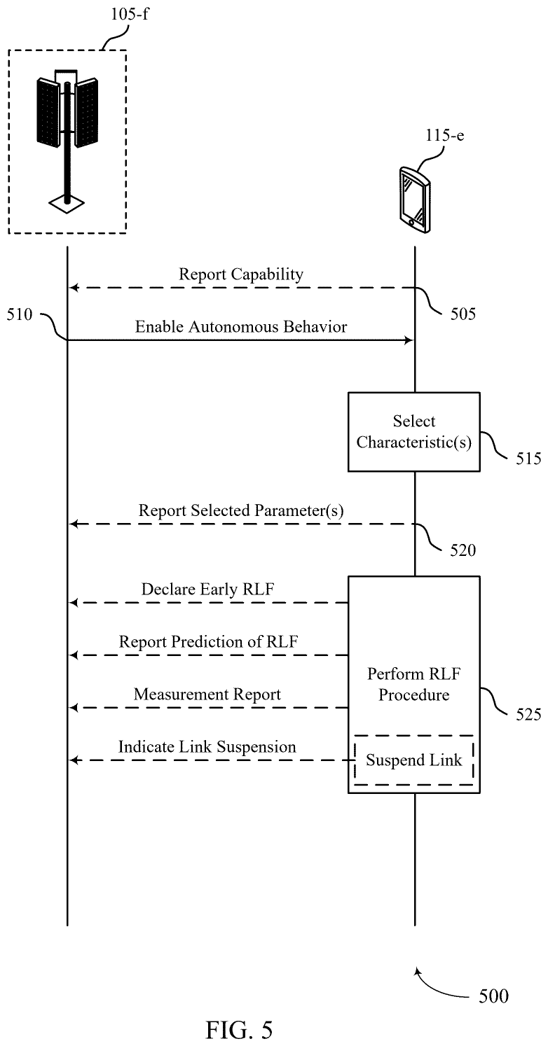

FIG. 5 shows an example of a process flow 500 that supports RLC service interruption reduction for wireless communications in accordance with one or more aspects of the present disclosure. In some cases, the process flow 300 may implement or be implemented by aspects of the wireless communications system 100, the wireless communications system 200, the process flows 400, the ML architecture 400, or any combination thereof. For example, the process flow 500 may include one or more UEs 115 (e.g., the UE 115-e) and one or more network entities 105 (e.g., the network entity 105-f), which may be examples of the corresponding devices as described herein. In the following description of the process flow 500, the operations between the UE 115-e and the network entity 105-f may be transmitted in a different order than the example order shown, or the operations performed by the UE 115-e and the network entity 105-f may be performed in different orders or at different times. Some operations may also be omitted from the process flow 500, and other operations may be added to the process flow 500.

In some cases, at 505, the UE 115-e may transmit, to the network entity 105-f, a capability message indicative of a capability of the UE 115-e to predict an RLF

At 510, the UE 115-c may obtain configuration information that enables the UE 115-e to select (e.g., autonomously) one or more characteristics of a RLF procedure. In some cases, the configuration information may be indicative of one or more ranges of parameter values associated with prediction of an RLF. In some examples (e.g., as depicted in FIG. 5), the UE 115-e may obtain the configuration information by receiving a first control message including the configuration information. In such cases, the first control message may be received by the UE 115-c based on the UE 115-e transmitting the capability message. Additionally, or alternatively (e.g., not depicted), the UE 115-e may obtain the configuration information from a higher layer (e.g., upper layer) at the UE 115-c, such as a MAC layer, an RRC layer, an RLC layer, or any combination thereof.

Additionally, or alternatively, the configuration information may be indicative of a threshold performance metric associated with prediction of RLF, one or more fallback procedures associated with failing to satisfy the threshold performance metric, or both. In such cases, the one or more fallback procedures may include performing a second RLF procedure in accordance with one or more configured characteristics, rather than the one or more selected characteristics, in accordance with a performance metric associated with the RLF procedure failing to satisfy the threshold performance metric, transmitting a report indicative of the performance metric associated with the RLF procedure failing to satisfy the threshold performance metric, disabling the selection of the one or more characteristics of the RLF procedure based on the performance metric associated with the RLF procedure failing to satisfy the threshold performance metric, or any combination thereof

At 515, the UE 115-e may select (e.g., autonomously) the one or more characteristics of the RLF procedure in accordance with the configuration information.

In some cases, to select the one or more characteristics of the RLF procedure, the UE 115-e may select one or more parameter values (e.g., a value of maxRetxThresholdRLF, a value of maxRetxThresholdReport, a value of earlyRLFRetxThreshold, or any combination thereof) associated with prediction of an RLF. In such cases, each parameter value from the one or more selected parameter values may be selected from a respective range of parameter values included in the one or more ranges of parameter values.

Additionally, or alternatively, the one or more selected parameter values may be selected in accordance with one or more measurements performed by the UE 115-e, one or more operational parameters associated with the UE 115-e, one or more conditions associated with the UE 115-e, or any combination thereof. For example, in some cases, to select the one or more parameter values, the UE 115-e may input, into an ML model, the one or more measurements performed by the UE 115-e, the one or more operational parameters associated with the UE 115-e, the one or more conditions associated with the UE 115-e, or any combination thereof, where the one or more parameter values are selected in accordance with an output of the ML model.

Additionally, or alternatively, to select the one or more characteristics of the RLF procedure, the UE 115-e may select one or more actions to be performed by the UE 115-e in response to the prediction of the RLF, a detection of the RLF, or both.

In some cases, at 520, the UE 115-e may transmit, to the network entity 105-f, a second control message indicative of the one or more selected parameter values.

At 525, the UE 115-e may perform the RLF procedure in accordance with the one or more selected characteristic. For example, to perform the RLF procedure, the UE 115-e may monitor for one or more retransmissions relative to the one or more parameter values associated with the prediction of the RLF and may predict the RLF.

Additionally, or alternatively, the RLF procedure may include the one or more actions selected by the UE 115-e. For example, in some cases, to perform the RLF procedure, the UE 115-e may transmit a message declaring early RLF (e.g., indicative of the RLF) in response to the prediction of the RLF, the detection of the RLF, or both, where the one or more actions selected by the UE 115-e include the transmission of the message. In such cases, the prediction of the RLF, the detection of the RLF, or both, may be in accordance with detection of a threshold quantity of retransmissions, where the threshold quantity is based on the one or more parameter values.

Additionally, or alternatively, in some cases, to perform the RLF procedure, the UE 115-e may transmit an indication of the prediction of the RLF in response to the prediction of the RLF, where the one or more actions selected by the UE 115-e include transmission of the indication. In such cases, the indication of the prediction of the RLF may include an indication of the threshold quantity of retransmissions detected by the UE 115-c.

Additionally, or alternatively, to perform the RLF procedure, the UE 115-e may transmit a measurement report in response to the prediction of the RLF, the detection of the RLF, or both, where the one or more actions selected by the UE 115-e include transmission of the measurement report.

Additionally, or alternatively, the UE 115-e may be associated with a first communication link and a second communication link in accordance with a dual connectivity configuration. In such cases, to perform the RLF procedure, the UE 115-e may suspend the first communication link in response to the prediction of the RLF or the detection of the RLF, where the first communication link is associated with the RLF, and where the one or more actions selected by the UE 115-e include suspension of the first communication link.

In some cases, the UE 115-e may input one or more features associated with RLF into the ML model configured to predict the RLF, where performance of the RLF procedure includes prediction of the RLF in accordance with an output of the ML model. In such cases, the UE 115-e may receive an additional control message indicative of one or more model parameters associated with the ML model, such that inputting the one or more features into the ML model is in accordance with the one or more model parameters. Additionally, or alternatively, the UE 115-e may store an indication of the one or more selected characteristics of the RLF procedure, where the one or more selected characteristics includes the one or more parameter values associated with prediction of the RLF, one or more first actions performed by the UE 115-e in response to the prediction of the RLF, one or more second actions performed by the UE 115-e in response to the detection of the RLF, a quantity of retransmissions associated with the prediction of the RLF or the detection of the RLF, or any combination thereof.

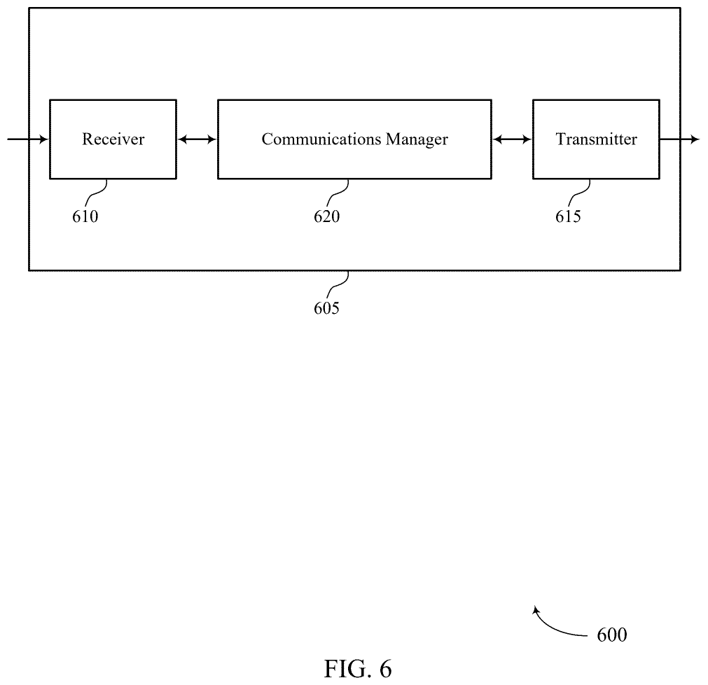

FIG. 6 shows a block diagram 600 of a device 605 that supports RLC service interruption reduction for wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to RLC service interruption reduction for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RLC service interruption reduction for wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of RLC service interruption reduction for wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for obtaining configuration information that enables the UE to select one or more characteristics of a RLF procedure. The communications manager 620 is capable of, configured to, or operable to support a means for selecting, by the UE, the one or more characteristics of the RLF procedure in accordance with the configuration information. The communications manager 620 is capable of, configured to, or operable to support a means for performing the RLF procedure in accordance with the one or more selected characteristics.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for RLC service interruption reduction, which may result in reduced processing, reduced power consumption, and more efficient utilization of communication resources, among other advantages.

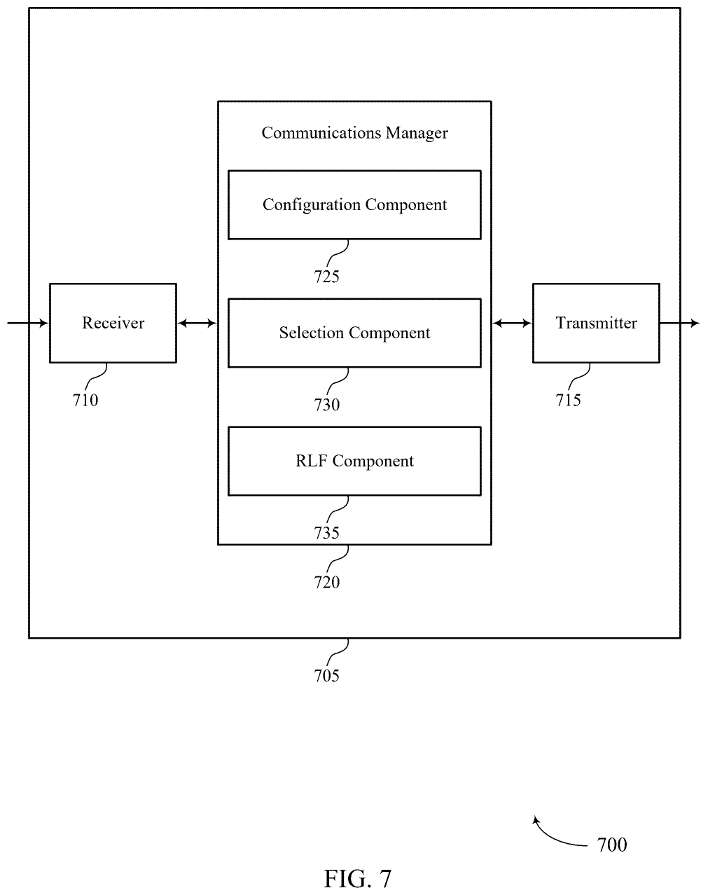

FIG. 7 shows a block diagram 700 of a device 705 that supports RLC service interruption reduction for wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to RLC service interruption reduction for wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RLC service interruption reduction for wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of RLC service interruption reduction for wireless communications as described herein. For example, the communications manager 720 may include a configuration component 725, a selection component 730, an RLF component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for obtaining configuration information that enables the UE to select one or more characteristics of a RLF procedure. The selection component 730 is capable of, configured to, or operable to support a means for selecting, by the UE, the one or more characteristics of the RLF procedure in accordance with the configuration information. The RLF component 735 is capable of, configured to, or operable to support a means for performing the RLF procedure in accordance with the one or more selected characteristics.

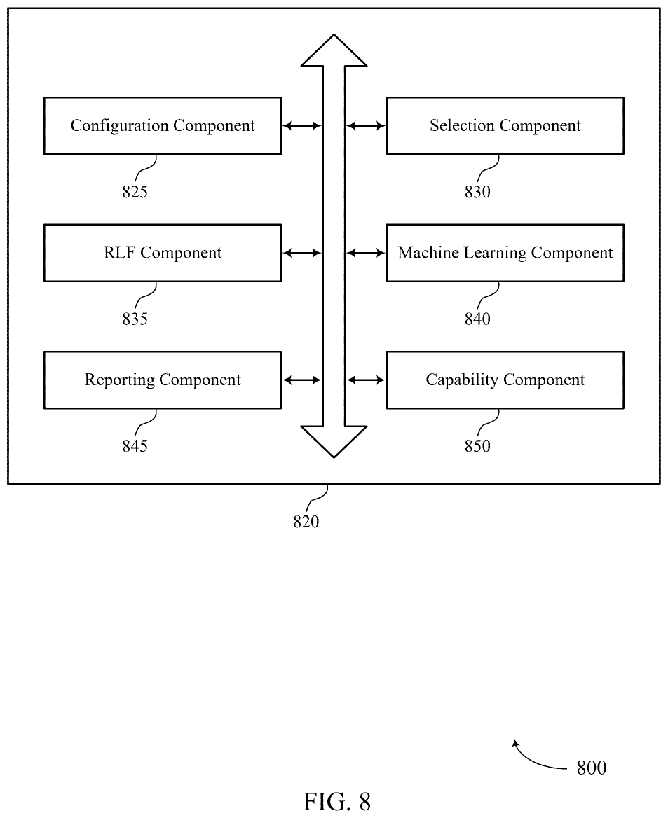

FIG. 8 shows a block diagram 800 of a communications manager 820 that supports RLC service interruption reduction for wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of RLC service interruption reduction for wireless communications as described herein. For example, the communications manager 820 may include a configuration component 825, a selection component 830, an RLF component 835, a machine learning component 840, a reporting component 845, a capability component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration component 825 is capable of, configured to, or operable to support a means for obtaining configuration information that enables the UE to select one or more characteristics of a RLF procedure. The selection component 830 is capable of, configured to, or operable to support a means for selecting, by the UE, the one or more characteristics of the RLF procedure in accordance with the configuration information. The RLF component 835 is capable of, configured to, or operable to support a means for performing the RLF procedure in accordance with the one or more selected characteristics.

In some examples, to support selecting the one or more characteristics of the RLF procedure, the selection component 830 is capable of, configured to, or operable to support a means for selecting one or more parameter values associated with prediction of an RLF, where the RLF procedure includes the prediction of the RLF.

In some examples, the reporting component 845 is capable of, configured to, or operable to support a means for transmitting a control message indicative of the one or more selected parameter values.

In some examples, the configuration information is indicative of one or more ranges of parameter values associated with the prediction of the RLF. In some examples, each parameter value from the one or more selected parameter values is selected from a respective range of parameter values included in the one or more ranges of parameter values.

In some examples, the one or more selected parameter values include a first threshold quantity of retransmissions that results in transmission of an RLF report, a second threshold quantity of retransmissions that results in the prediction of the RLF, or both.

In some examples, the one or more selected parameter values are selected in accordance with one or more measurements performed by the UE, one or more operational parameters associated with the UE, one or more conditions associated with the UE, or any combination thereof.

In some examples, to support selecting the one or more parameter values, the machine learning component 840 is capable of, configured to, or operable to support a means for inputting, into a ML model, the one or more measurements performed by the UE, the one or more operational parameters associated with the UE, the one or more conditions associated with the UE, or any combination thereof, where the one or more parameter values are selected in accordance with an output of the ML model.

In some examples, the one or more selected parameter values are selected in response to RLC establishment, an RLC update, a handover, an SCell addition, or any combination thereof.

In some examples, the one or more selected parameter values are associated with one or more parameters. In some examples, the one or more selected parameter values for the one or more parameters are smaller than one or more configured parameter values indicated to the UE for the same one or more parameters.

In some examples, to support selecting the one or more characteristics of the RLF procedure, the selection component 830 is capable of, configured to, or operable to support a means for selecting one or more actions to be performed by the UE in response to a prediction of an RLF, a detection of the RLF, or both. In some examples, to support selecting the one or more characteristics of the RLF procedure, the RLF component 835 is capable of, configured to, or operable to support a means for performing the one or more selected actions in response to the prediction of the RLF, the detection of the RLF, or both.

In some examples, to support performing the RLF procedure in accordance with the one or more selected characteristics, the RLF component 835 is capable of, configured to, or operable to support a means for transmitting a message indicative of the RLF in response to the prediction of the RLF, the detection of the RLF, or both, where the one or more selected actions include transmission of the message, and where the prediction of the RLF, the detection of the RLF, or both, is in accordance with detection of a threshold quantity of retransmissions.

In some examples, to support performing the RLF procedure in accordance with the one or more selected characteristics, the RLF component 835 is capable of, configured to, or operable to support a means for transmitting an indication of the prediction of the RLF in response to the prediction of the RLF, where the one or more selected actions include transmission of the indication.

In some examples, the indication of the prediction of the RLF includes an indication of a threshold quantity of retransmissions detected by the UE.

In some examples, to support performing the RLF procedure in accordance with the one or more selected characteristics, the RLF component 835 is capable of, configured to, or operable to support a means for transmitting a measurement report in response to the prediction of the RLF, the detection of the RLF, or both, where the one or more selected actions include transmission of the measurement report.

In some examples, to support performing the RLF procedure in accordance with the one or more selected characteristics, the RLF component 835 is capable of, configured to, or operable to support a means for suspending the first communication link in response to the prediction of the RLF or the detection of the RLF, where the first communication link is associated with the RLF, and where the one or more selected actions include suspension of the first communication link.

In some examples, the RLF component 835 is capable of, configured to, or operable to support a means for transmitting, via the second communication link and in response to suspension of the first communication link, an indication of the prediction of the RLF associated with the first communication link or an indication of the detection of the RLF associated with the first communication link.

In some examples, the machine learning component 840 is capable of, configured to, or operable to support a means for inputting one or more features associated with RLF into a ML model configured to predict an RLF, where performance of the RLF procedure includes prediction of the RLF in accordance with an output of the ML model.

In some examples, the one or more features include a quantity of bytes, one or more BLERs, one or more retransmission timers, one or more channel metrics, one or more parameters associated with a DRX cycle, a quantity of SR failures, a quantity of control message failures, a quantity of DRBs, one or more transmission states of the UE, one or more thermal mitigation triggers, one or more conditions associated with one or more neighboring network entities, or any combination thereof.

In some examples, the capability component 850 is capable of, configured to, or operable to support a means for transmitting a capability message indicative of a capability of the UE to predict the RLF, where inputting the one or more features into the ML model is in accordance with the capability of the UE.

In some examples, the machine learning component 840 is capable of, configured to, or operable to support a means for receiving a control message indicative of one or more model parameters associated with the ML model, where inputting the one or more features into the ML model is in accordance with the one or more model parameters.

In some examples, the machine learning component 840 is capable of, configured to, or operable to support a means for storing an indication of the one or more selected characteristics of the RLF procedure, where the one or more selected characteristics include one or more parameter values associated with prediction of an RLF, one or more first actions performed by the UE in response to a prediction of the RLF, one or more second actions performed by the UE in response to a detection of the RLF, a quantity of retransmissions associated with the prediction of the RLF or the detection of the RLF, or any combination thereof.

In some examples, the configuration information is further indicative of a threshold performance metric associated with prediction of RLF, one or more fallback procedures associated with failing to satisfy the threshold performance metric, or both.

In some examples, the RLF component 835 is capable of, configured to, or operable to support a means for performing a second RLF procedure in accordance with one or more configured characteristics, rather than the one or more autonomously selected characteristics, in accordance with a performance metric associated with the RLF procedure failing to satisfy the threshold performance metric.

In some examples, the reporting component 845 is capable of, configured to, or operable to support a means for transmitting a report indicative of a performance metric associated with the RLF procedure failing to satisfy the threshold performance metric.

In some examples, the reporting component 845 is capable of, configured to, or operable to support a means for disabling the autonomous selection of the one or more characteristics of the RLF procedure in accordance with a performance metric associated with the RLF procedure failing to satisfy the threshold performance metric.

In some examples, to obtain the configuration information, the configuration component 825 is capable of, configured to, or operable to support a means for receiving, from a network entity, a control message indicative of the configuration information that enables the UE to autonomously select one or more characteristics of the RLF procedure, wherein selection of the one or more characteristics is based at least in part on reception of the control message.

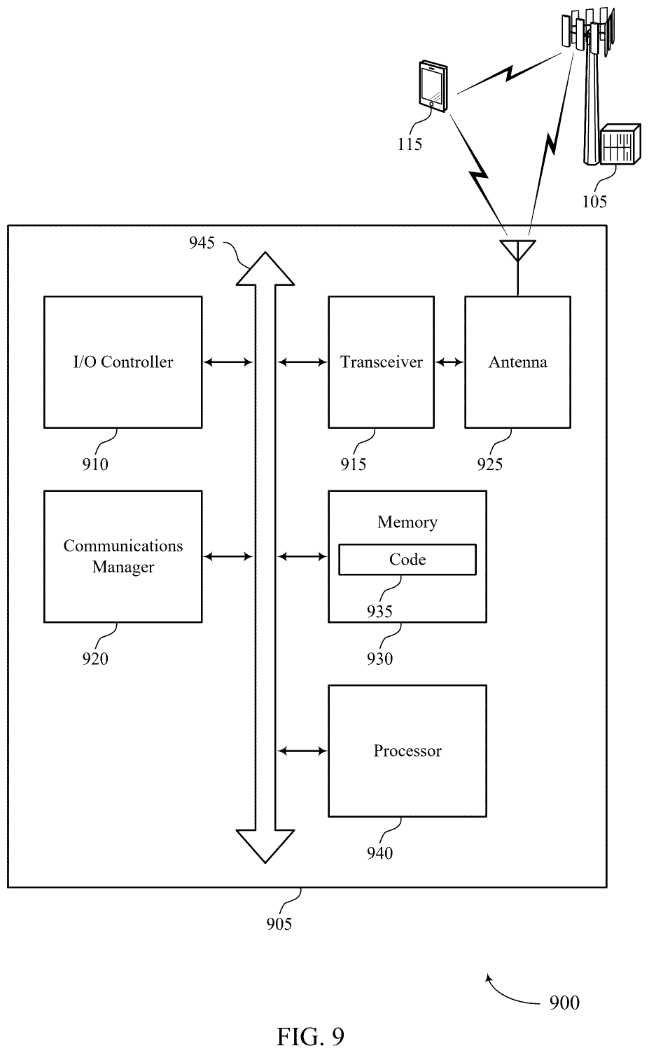

FIG. 9 shows a diagram of a system 900 including a device 905 that supports RLC service interruption reduction for wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting RLC service interruption reduction for wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for obtaining configuration information that enables the UE to select one or more characteristics of a RLF procedure. The communications manager 920 is capable of, configured to, or operable to support a means for selecting the one or more characteristics of the RLF procedure in accordance with the configuration information. The communications manager 920 is capable of, configured to, or operable to support a means for performing the RLF procedure in accordance with the one or more selected characteristics.

By including or configuring the communications manager 920 in accordance with examples as described herein, the device 905 may support techniques for RLC service interruption reduction, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of RLC service interruption reduction for wireless communications as described herein, or the at least one processor 940 and the at least one memory 930 may be otherwise configured to, individually or collectively, perform or support such operations.

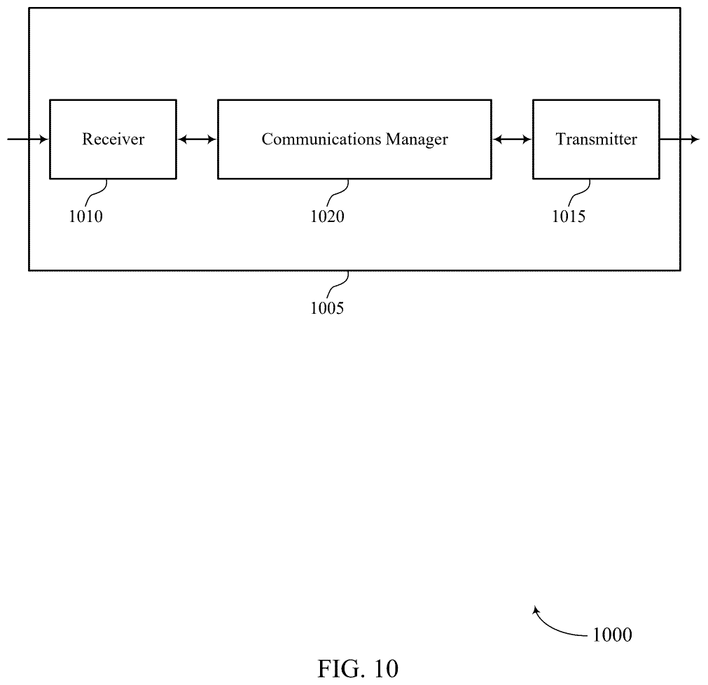

FIG. 10 shows a block diagram 1000 of a device 1005 that supports RLC service interruption reduction for wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of RLC service interruption reduction for wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting a first control message including configuration information that enables a UE to select one or more characteristics of a RLF procedure. The communications manager 1020 is capable of, configured to, or operable to support a means for receiving, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for RLC service interruption reduction, which may result in reduced processing, reduced power consumption, more efficient utilization of communication resources, among other advantages.

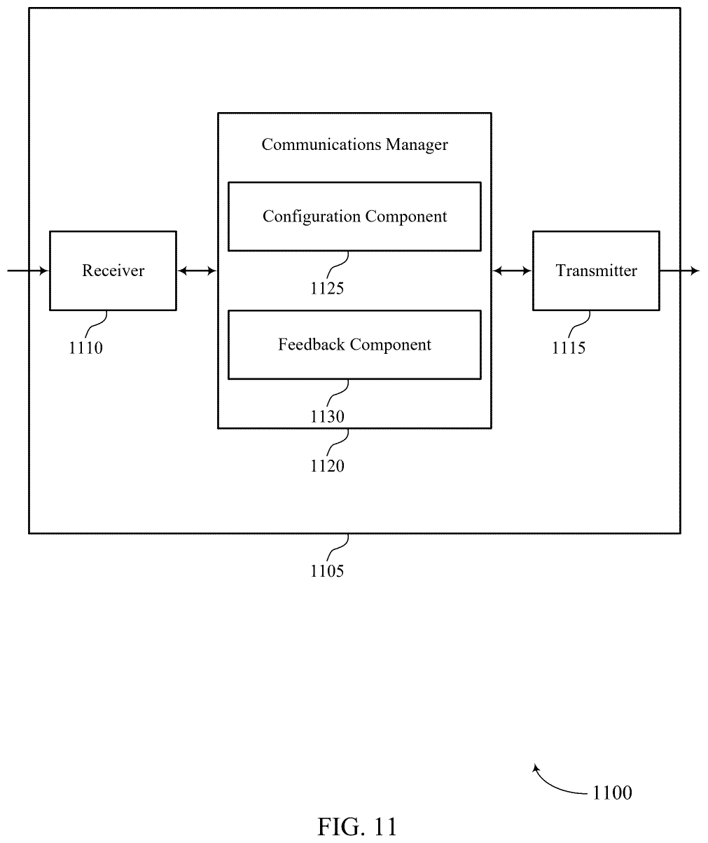

FIG. 11 shows a block diagram 1100 of a device 1105 that supports RLC service interruption reduction for wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of RLC service interruption reduction for wireless communications as described herein. For example, the communications manager 1120 may include a configuration component 1125 a feedback component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The configuration component 1125 is capable of, configured to, or operable to support a means for transmitting a first control message including configuration information that enables a UE to select one or more characteristics of a RLF procedure. The feedback component 1130 is capable of, configured to, or operable to support a means for receiving, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

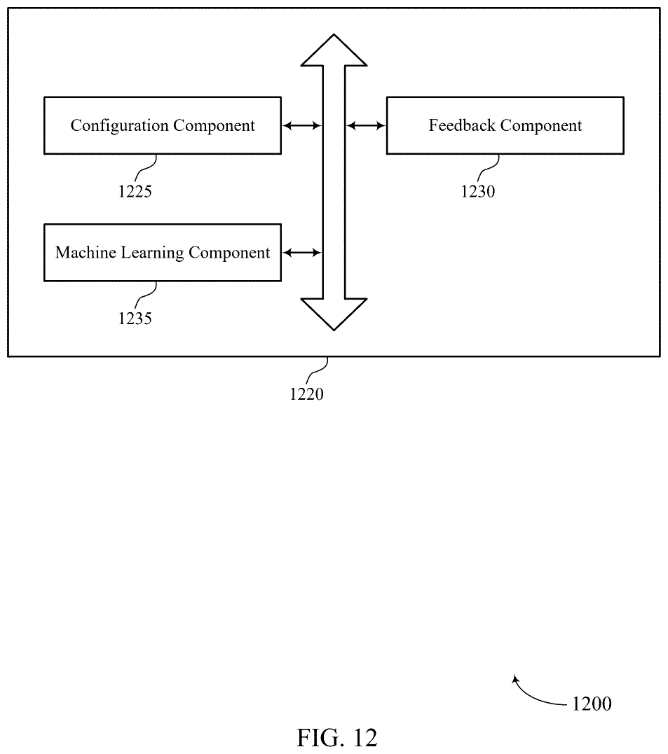

FIG. 12 shows a block diagram 1200 of a communications manager 1220 that supports RLC service interruption reduction for wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of RLC service interruption reduction for wireless communications as described herein. For example, the communications manager 1220 may include a configuration component 1225, a feedback component 1230, a machine learning component 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The configuration component 1225 is capable of, configured to, or operable to support a means for transmitting a first control message including configuration information that enables a UE to select one or more characteristics of a RLF procedure. The feedback component 1230 is capable of, configured to, or operable to support a means for receiving, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

In some examples, the configuration information is indicative of one or more ranges of parameter values associated with the prediction of the RLF, and the feedback component 1230 is capable of, configured to, or operable to support a means for receiving a third control message indicative of one or more parameter values selected by the UE from the one or more ranges of parameter values, where the prediction of the RLF, the detection of RLF at the UE, or both, are in accordance with the one or more selected parameter values.

In some examples, the one or more autonomously selected parameter values includes a first threshold quantity of retransmissions that results in transmission of an RLF report, a second threshold quantity of retransmissions that results in the prediction of the RLF, or both.

In some examples, reception of the third control message is in response to RLC establishment, an RLC update, a handover, an SCell addition, or any combination thereof.

In some examples, the one or more selected parameter values are associated with one or more parameters. In some examples, the one or more selected parameter values for the one or more parameters are smaller than one or more configured parameter values indicated by the network entity for the same one or more parameters.

In some examples, to support receiving the indication of the prediction of the RLF, the detection of the RLF at the UE, or both, the feedback component 1230 is capable of, configured to, or operable to support a means for receiving a message indicative of the RLF.

In some examples, to support receiving the indication of the prediction of the RLF, the detection of the RLF at the UE, or both, the feedback component 1230 is capable of, configured to, or operable to support a means for receiving the indication of the prediction of the RLF, where the indication of the prediction of the RLF includes an indication of a threshold quantity of retransmissions detected by the UE.

In some examples, to support receiving the indication of the prediction of the RLF, the detection of the RLF at the UE, or both, the feedback component 1230 is capable of, configured to, or operable to support a means for receiving a measurement report in response to the prediction of the RLF, the detection of the RLF, or both.

In some examples, to support receiving the indication of the prediction of the RLF, the detection of the RLF at the UE, or both, the feedback component 1230 is capable of, configured to, or operable to support a means for receiving, via the second communication link, an indication of the prediction of the RLF associated with the first communication link or an indication of the detection of the RLF associated with the first communication link.

In some examples, the feedback component 1230 is capable of, configured to, or operable to support a means for receiving a capability message indicative of a capability of the UE to predict the RLF, where transmission of the first control message is in response to reception of the capability message.

In some examples, the machine learning component 1235 is capable of, configured to, or operable to support a means for transmitting a third message indicative of one or more model parameters associated with a ML model, where the one or more model parameters are associated with the prediction of the RLF, the detection of the RLF at the UE, or both.

In some examples, the configuration information is further indicative of a threshold performance metric associated with prediction of RLF, one or more fallback procedures associated with failing to satisfy the threshold performance metric, or both.

In some examples, the feedback component 1230 is capable of, configured to, or operable to support a means for receiving a report indicative of a performance metric associated with the RLF procedure failing to satisfy the threshold performance metric.

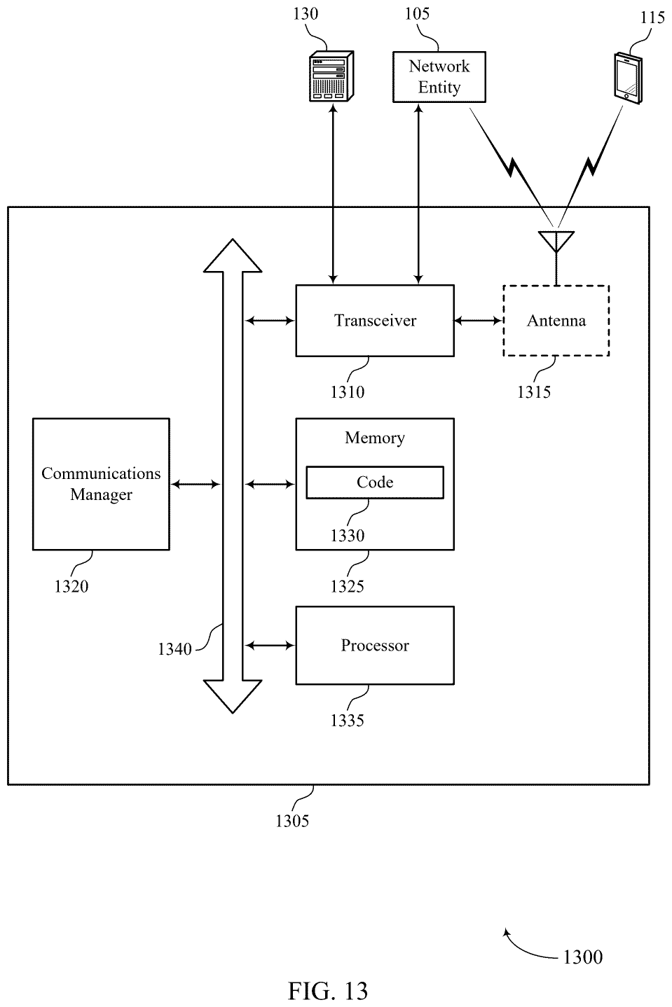

FIG. 13 shows a diagram of a system 1300 including a device 1305 that supports RLC service interruption reduction for wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting RLC service interruption reduction for wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting a first control message including configuration information that enables a UE to select one or more characteristics of a RLF procedure. The communications manager 1320 is capable of, configured to, or operable to support a means for receiving, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE.

By including or configuring the communications manager 1320 in accordance with examples as described herein, the device 1305 may support techniques for RLC service interruption reduction, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of RLC service interruption reduction for wireless communications as described herein, or the at least one processor 1335 and the at least one memory 1325 may be otherwise configured to, individually or collectively, perform or support such operations.

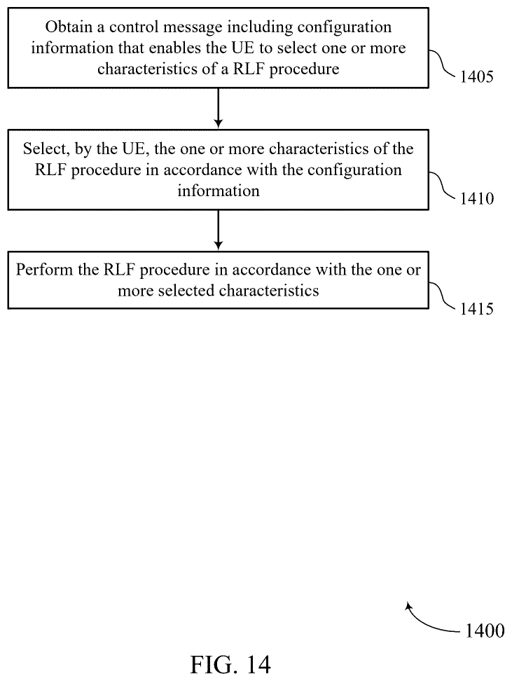

FIG. 14 shows a flowchart illustrating a method 1400 that supports RLC service interruption reduction for wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include obtaining configuration information that enables the UE to select one or more characteristics of a RLF procedure. The operations of 1405 may be performed in accordance with examples as disclosed herein. In some examples, aspects of the operations of 1405 may be performed by a configuration component 825 as described with reference to FIG. 8.

At 1410, the method may include selecting, by the UE, the one or more characteristics of the RLF procedure in accordance with the configuration information. The operations of 1410 may be performed in accordance with examples as disclosed herein. In some examples, aspects of the operations of 1410 may be performed by a selection component 830 as described with reference to FIG. 8.

At 1415, the method may include performing the RLF procedure in accordance with the one or more selected characteristics. The operations of 1415 may be performed in accordance with examples as disclosed herein. In some examples, aspects of the operations of 1415 may be performed by an RLF component 835 as described with reference to FIG. 8.

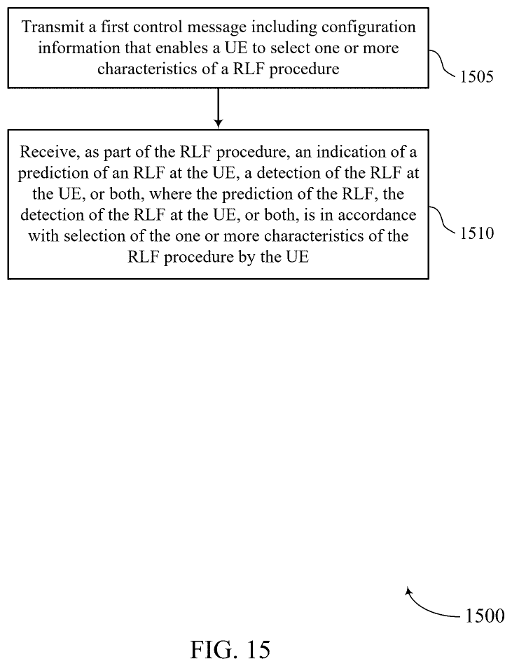

FIG. 15 shows a flowchart illustrating a method 1500 that supports RLC service interruption reduction for wireless communications in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a first control message including configuration information that enables a UE to select one or more characteristics of a RLF procedure. The operations of 1505 may be performed in accordance with examples as disclosed herein. In some examples, aspects of the operations of 1505 may be performed by a configuration component 1225 as described with reference to FIG. 12.

At 1510, the method may include receiving, as part of the RLF procedure, an indication of a prediction of an RLF at the UE, a detection of the RLF at the UE, or both, where the prediction of the RLF, the detection of the RLF at the UE, or both, is in accordance with selection of the one or more characteristics of the RLF procedure by the UE. The operations of 1510 may be performed in accordance with examples as disclosed herein. In some examples, aspects of the operations of 1510 may be performed by a feedback component 1230 as described with reference to FIG. 12.

The following provides an overview of aspects of the present disclosure:

Aspect 1: A method for wireless communications at a UE, comprising: obtaining configuration information that enables the UE to select one or more characteristics of a RLF procedure; selecting, by the UE, the one or more characteristics of the RLF procedure in accordance with the configuration information; and performing the RLF procedure in accordance with the one or more selected characteristics.

Aspect 2: The method of aspect 1, wherein autonomously selecting the one or more characteristics of the RLF procedure comprises: selecting one or more parameter values associated with prediction of an RLF, wherein the RLF procedure comprises the prediction of the RLF.

Aspect 3: The method of aspect 2, further comprising: transmitting a control message indicative of the one or more selected parameter values.

Aspect 4: The method of any of aspects 2 through 3, wherein the configuration information is indicative of one or more ranges of parameter values associated with the prediction of the RLF, and each parameter value from the one or more selected parameter values is selected from a respective range of parameter values included in the one or more ranges of parameter values.

Aspect 5: The method of any of aspects 2 through 4, wherein the one or more selected parameter values comprise a first threshold quantity of retransmissions that results in transmission of an RLF report, a second threshold quantity of retransmissions that results in the prediction of the RLF, or both.

Aspect 6: The method of any of aspects 2 through 5, wherein the one or more selected parameter values are selected in accordance with one or more measurements performed by the UE, one or more operational parameters associated with the UE, one or more conditions associated with the UE, or any combination thereof.

Aspect 7: The method of aspect 6, wherein selecting the one or more parameter values comprises: inputting, into an ML model, the one or more measurements performed by the UE, the one or more operational parameters associated with the UE, the one or more conditions associated with the UE, or any combination thereof, wherein the one or more parameter values are selected in accordance with an output of the ML model.

Aspect 8: The method of any of aspects 2 through 7, wherein the one or more selected parameter values are selected in response to RLC establishment, a RLC update, a handover, a secondary cell addition, or any combination thereof.

Aspect 9: The method of any of aspects 2 through 8, wherein the one or more selected parameter values are associated with one or more parameters, and the one or more selected parameter values for the one or more parameters are smaller than one or more configured parameter values indicated to the UE for the same one or more parameters.

Aspect 10: The method of any of aspects 1 through 9, wherein selecting the one or more characteristics of the RLF procedure comprises: selecting one or more actions to be performed by the UE in response to a prediction of an RLF, a detection of the RLF, or both, wherein performing the RLF procedure comprises performing the one or more actions performed in response to the prediction of the RLF, the detection of the RLF, or both.

Aspect 11: The method of aspect 10, wherein performing the RLF procedure in accordance with the one or more selected characteristics comprises: transmitting a message indicative of the RLF in response to the prediction of the RLF, the detection of the RLF, or both, wherein the one or more actions comprises transmission of the message, and wherein the prediction of the RLF, the detection of the RLF, or both, is in accordance with detection of a threshold quantity of retransmissions.

Aspect 12: The method of any of aspects 10 through 11, wherein performing the RLF procedure in accordance with the one or more selected characteristics comprises: transmitting an indication of the prediction of the RLF in response to the prediction of the RLF, wherein the one or more actions comprises transmission of the indication.

Aspect 13: The method of aspect 12, wherein the indication of the prediction of the RLF comprises an indication of a threshold quantity of retransmissions detected by the UE.

Aspect 14: The method of any of aspects 10 through 13, wherein performing the RLF procedure in accordance with the one or more autonomously selected characteristics comprises: transmitting a measurement report in response to the prediction of the RLF, the detection of the RLF, or both, wherein the one or more actions comprises transmission of the measurement report.

Aspect 15: The method of any of aspects 10 through 14, wherein the UE is associated with a first communication link and a second communication link in accordance with a dual connectivity configuration, and wherein performing the RLF procedure in accordance with the one or more selected characteristics comprises: suspending the first communication link in response to the prediction of the RLF or the detection of the RLF, wherein the first communication link is associated with the RLF, and wherein the one or more actions comprises suspension of the first communication link.

Aspect 16: The method of aspect 15, further comprising: transmitting, via the second communication link and in response to suspension of the first communication link, an indication of the prediction of the RLF associated with the first communication link or an indication of the detection of the RLF associated with the first communication link.

Aspect 17: The method of any of aspects 1 through 16, further comprising: inputting one or more features associated with RLF into an ML model configured to predict an RLF, wherein performance of the RLF procedure comprises prediction of the RLF in accordance with an output of the ML model.

Aspect 18: The method of aspect 17, wherein the one or more features comprise a quantity of bytes, one or more block error rates, one or more retransmission timers, one or more channel metrics, one or more parameters associated with a discontinuous reception cycle, a quantity of scheduling request failures, a quantity of control message failures, a quantity of data radio bearers, one or more transmission states of the UE, one or more thermal mitigation triggers, one or more conditions associated with one or more neighboring network entities, or any combination thereof.

Aspect 19: The method of any of aspects 17 through 18, further comprising: transmitting a capability message indicative of a capability of the UE to predict the RLF, wherein inputting the one or more features into the ML model is in accordance with the capability of the UE.

Aspect 20: The method of any of aspects 17 through 19, further comprising: receiving a control message indicative of one or more model parameters associated with the ML model, wherein inputting the one or more features into the ML model is in accordance with the one or more model parameters.

Aspect 21: The method of any of aspects 1 through 20, further comprising: storing an indication of the one or more selected characteristics of the RLF procedure, wherein the one or more selected characteristics comprise one or more parameter values associated with prediction of an RLF, one or more first actions performed by the UE in response to a prediction of the RLF, one or more second actions performed by the UE in response to a detection of the RLF, a quantity of retransmissions associated with the prediction of the RLF or the detection of the RLF, or any combination thereof.

Aspect 22: The method of any of aspects 1 through 21, wherein the configuration information is further indicative of a threshold performance metric associated with prediction of RLF, one or more fallback procedures associated with failing to satisfy the threshold performance metric, or both.

Aspect 23: The method of aspect 22, further comprising: performing a second RLF procedure in accordance with one or more configured characteristics, rather than the one or more selected characteristics, based at least in part on a performance metric associated with the RLF procedure failing to satisfy the threshold performance metric.

Aspect 24: The method of any of aspects 22 through 23, further comprising: transmitting a report indicative of a performance metric associated with the RLF procedure failing to satisfy the threshold performance metric.

Aspect 25: The method of any of aspects 22 through 24, further comprising: disabling the selection of the one or more characteristics of the RLF procedure based at least in part on a performance metric associated with the RLF procedure failing to satisfy the threshold performance metric.

Aspect 26: The method of any of aspects 1 through 25, wherein obtaining the configuration information comprises: receiving, from a network entity, a control message indicative of the configuration information that enables the UE to autonomously select one or more characteristics of the RLF procedure, wherein selection of the one or more characteristics is based at least in part on reception of the control message.

Aspect 27: A method for wireless communications at a network entity, comprising: transmitting a first control message comprising configuration information that enables a UE to select one or more characteristics of a RLF procedure; and receiving, as part of the RLF procedure, an indication of a prediction of an RLF at the UE, a detection of the RLF at the UE, or both, wherein the prediction of the RLF, the detection of the RLF at the UE, or both, is in accordance with selection of the one or more characteristics of the RLF procedure by the UE.

Aspect 28: The method of aspect 27, wherein the configuration information is indicative of one or more ranges of parameter values associated with the prediction of the RLF, the method further comprising: receiving a third control message indicative of one or more parameter values selected by the UE from the one or more ranges of parameter values, wherein the prediction of the RLF, the detection of RLF at the UE, or both, are in accordance with the one or more selected parameter values.

Aspect 29: The method of aspect 28, wherein the one or more selected parameter values comprises a first threshold quantity of retransmissions that results in transmission of an RLF report, a second threshold quantity of retransmissions that results in the prediction of the RLF, or both.

Aspect 30: The method of any of aspects 28 through 29, wherein reception of the third control message is in response to RLC establishment, a RLC update, a handover, a secondary cell addition, or any combination thereof.

Aspect 31: The method of any of aspects 28 through 30, wherein the one or more selected parameter values are associated with one or more parameters, and the one or more selected parameter values for the one or more parameters are smaller than one or more configured parameter values indicated by the network entity for the same one or more parameters.

Aspect 32: The method of any of aspects 27 through 31, wherein receiving the indication of the prediction of the RLF, the detection of the RLF at the UE, or both, comprises: receiving a message indicative of the RLF.

Aspect 33: The method of any of aspects 27 through 32, wherein receiving the indication of the prediction of the RLF, the detection of the RLF at the UE, or both, comprises: receiving the indication of the prediction of the RLF, wherein the indication of the prediction of the RLF comprises an indication of a threshold quantity of retransmissions detected by the UE.

Aspect 34: The method of any of aspects 27 through 33, wherein receiving the indication of the prediction of the RLF, the detection of the RLF at the UE, or both, comprises: receiving a measurement report in response to the prediction of the RLF, the detection of the RLF, or both.

Aspect 35: The method of any of aspects 27 through 34, wherein the UE is associated with a first communication link and a second communication link in accordance with a dual connectivity configuration, and wherein receiving the indication of the prediction of the RLF, the detection of the RLF at the UE, or both, comprises: receiving, via the second communication link, an indication of the prediction of the RLF associated with the first communication link or an indication of the detection of the RLF associated with the first communication link.

Aspect 36: The method of any of aspects 27 through 35, further comprising: receiving a capability message indicative of a capability of the UE to predict the RLF, wherein transmission of the first control message is in response to reception of the capability message.

Aspect 37: The method of any of aspects 27 through 36, further comprising: transmitting a third message indicative of one or more model parameters associated with an ML model, wherein the one or more model parameters are associated with the prediction of the RLF, the detection of the RLF at the UE, or both.

Aspect 38: The method of any of aspects 27 through 37, wherein the configuration information is further indicative of a threshold performance metric associated with prediction of RLF, one or more fallback procedures associated with failing to satisfy the threshold performance metric, or both.

Aspect 39: The method of aspect 38, further comprising: receiving a report indicative of a performance metric associated with the RLF procedure failing to satisfy the threshold performance metric.

Aspect 40: A UE for wireless communications, comprising one or more memories storing processor-executable code, and one or more processors coupled with the one or more memories and individually or collectively operable to execute the code to cause the UE to perform a method of any of aspects 1 through 25.

Aspect 41: A UE for wireless communications, comprising at least one means for performing a method of any of aspects 1 through 25.

Aspect 42: A non-transitory computer-readable medium storing code for wireless communications, the code comprising instructions executable by one or more processors to perform a method of any of aspects 1 through 25.

Aspect 43: A network entity for wireless communications, comprising one or more memories storing processor-executable code, and one or more processors coupled with the one or more memories and individually or collectively operable to execute the code to cause the network entity to perform a method of any of aspects 27 through 39.

Aspect 44: A network entity for wireless communications, comprising at least one means for performing a method of any of aspects 27 through 39.

Aspect 45: A non-transitory computer-readable medium storing code for wireless communications, the code comprising instructions executable by one or more processors to perform a method of any of aspects 27 through 39.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
obtain configuration information that enables the UE to select one or more characteristics of a radio link failure (RLF) procedure;
select, by the UE, the one or more characteristics of the RLF procedure in accordance with the configuration information; and
perform the RLF procedure in accordance with the one or more selected characteristics.

2. The UE of claim 1, wherein, to select the one or more characteristics of the RLF procedure, the one or more processors are individually or collectively operable to execute the code to cause the UE to:
select one or more parameter values associated with prediction of an RLF, wherein the RLF procedure comprises the prediction of the RLF.

3. The UE of claim 2, wherein the one or more processors are individually or collectively further operable to execute the code to cause the UE to:
transmit a control message indicative of the one or more selected parameter values.

4. The UE of claim 2, wherein the configuration information is indicative of one or more ranges of parameter values associated with the prediction of the RLF, and wherein each parameter value from the one or more selected parameter values is selected from a respective range of parameter values included in the one or more ranges of parameter values.

5. The UE of claim 2, wherein the one or more processors are individually or collectively operable to execute the code to cause the UE to select the one or more parameter values in accordance with one or more measurements performed by the UE, one or more operational parameters associated with the UE, one or more conditions associated with the UE, or any combination thereof.

6. The UE of claim 5, wherein, to select the one or more parameter values, the one or more processors are individually or collectively operable to execute the code to cause the UE to:
input, into a machine learning model, the one or more measurements performed by the UE, the one or more operational parameters associated with the UE, the one or more conditions associated with the UE, or any combination thereof; and
select the one or more parameter values in accordance with an output of the machine learning model.

7. The UE of claim 1, wherein:
to select the one or more characteristics of the RLF procedure, the one or more processors are individually or collectively operable to execute the code to cause the UE to select one or more actions to be performed by the UE in response to a prediction of an RLF, a detection of the RLF, or both; and
to perform the RLF procedure in accordance with the one or more selected characteristics, the one or more processors are individually or collectively operable to execute the code to cause the UE to perform the one or more selected actions in response to the prediction of the RLF, the detection of the RLF, or both.

8. The UE of claim 7, wherein, to perform the RLF procedure in accordance with the one or more selected characteristics, the one or more processors are individually or collectively operable to execute the code to cause the UE to:
transmit a message indicative of the RLF in response to the prediction of the RLF, the detection of the RLF, or both, wherein the one or more selected actions comprise transmission of the message, and wherein the prediction of the RLF, the detection of the RLF, or both, is in accordance with detection of a threshold quantity of retransmissions.

9. The UE of claim 7, wherein, to perform the RLF procedure in accordance with the one or more selected characteristics, the one or more processors are individually or collectively operable to execute the code to cause the UE to:
transmit an indication of the prediction of the RLF in response to the prediction of the RLF, wherein the one or more selected actions comprise transmission of the indication.

10. The UE of claim 7, wherein, to perform the RLF procedure in accordance with the one or more selected characteristics, the one or more processors are individually or collectively operable to execute the code to cause the UE to:
transmit a measurement report in response to the prediction of the RLF, the detection of the RLF, or both, wherein the one or more selected actions comprise transmission of the measurement report.

11. The UE of claim 7, wherein the UE is associated with a first communication link and a second communication link in accordance with a dual connectivity configuration, and wherein, to perform the RLF procedure in accordance with the one or more selected characteristics, the one or more processors are individually or collectively operable to execute the code to cause the UE to:
suspend the first communication link in response to the prediction of the RLF or the detection of the RLF, wherein the first communication link is associated with the RLF, and wherein the one or more selected actions comprise suspension of the first communication link.

12. The UE of claim 1, wherein the one or more processors are individually or collectively further operable to execute the code to cause the UE to:
input one or more features associated with RLF into a machine learning model configured to predict an RLF, wherein performance of the RLF procedure comprises prediction of the RLF in accordance with an output of the machine learning model.

13. The UE of claim 12, wherein the one or more processors are individually or collectively further operable to execute the code to cause the UE to:
transmit a capability message indicative of a capability of the UE to predict the RLF, wherein inputting the one or more features into the machine learning model is in accordance with the capability of the UE.

14. The UE of claim 12, wherein the one or more processors are individually or collectively further operable to execute the code to cause the UE to:
receive a control message indicative of one or more model parameters associated with the machine learning model, wherein inputting the one or more features into the machine learning model is in accordance with the one or more model parameters.

15. The UE of claim 1, wherein the one or more processors are individually or collectively further operable to execute the code to cause the UE to:
store an indication of the one or more selected characteristics of the RLF procedure, wherein the one or more selected characteristics comprise one or more parameter values associated with prediction of an RLF, one or more first actions performed by the UE in response to a prediction of the RLF, one or more second actions performed by the UE in response to a detection of the RLF, a quantity of retransmissions associated with the prediction of the RLF or the detection of the RLF, or any combination thereof.

16. The UE of claim 1, wherein the configuration information is further indicative of a threshold performance metric associated with prediction of RLF, one or more fallback procedures associated with failing to satisfy the threshold performance metric, or both.

17. The UE of claim 16, wherein the one or more processors are individually or collectively further operable to execute the code to cause the UE to:
transmit a report indicative of a performance metric associated with the RLF procedure failing to satisfy the threshold performance metric; and
disable the selection of the one or more characteristics of the RLF procedure in accordance with the performance metric failing to satisfy the threshold performance metric.

18. The UE of claim 16, wherein, to obtain the configuration information, the one or more processors are individually or collectively operable to execute the code to cause the UE to:
receive, from a network entity, a control message indicative of the configuration information that enables the UE to autonomously select one or more characteristics of the RLF procedure, wherein selection of the one or more characteristics is based at least in part on reception of the control message.

19. A method for wireless communications at a user equipment (UE), comprising:
obtaining configuration information that enables the UE to autonomously select one or more characteristics of a radio link failure (RLF) procedure;
selecting, by the UE, the one or more characteristics of the RLF procedure in accordance with the configuration information; and
performing the RLF procedure in accordance with the one or more selected characteristics.

20. A user equipment (UE) for wireless communications, comprising:
means for obtaining configuration information that enables the UE to select one or more characteristics of a radio link failure (RLF) procedure;
means for selecting, by the UE, the one or more characteristics of the RLF procedure in accordance with the configuration information; and
means for performing the RLF procedure in accordance with the one or more selected characteristics.
